(19) United States
(12) Patent Application Publication
(10) Pub. No.: US 2009/0254349 A1
(43) Pub. Date: Oct. 8, 2009

(54) SPEECH SYNTHESIZER

(76) Inventors: Yoshifumi Hirose, Kyoto (JP); Yumiko Kato, Osaka (JP); Takahiro Kamai, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/303,455

(22) PCT Filed: May 11, 2007
(86) PCT No.: PCT/JP2007/059765

§ 371 Date: Dec. 4, 2008

(30) Foreign Application Priority Data
Jun. 5, 2006 (JP) 2006-156429

(51) Int. Cl. G10L 13/06; G10L 13/08; G06F 17/30

(52) U.S. Cl. 704/260; 704/266; 707/3; 707/104.1; 707/E17.015; 707/E17.045; 704/E13.006; 704/E13.013

(57) ABSTRACT

A speech synthesizer can execute speech content editing at high speed and generate speech content easily. The speech synthesizer includes a small speech element DB (101), a small speech element selection unit (102), a small speech element concatenation unit (103), a prosody modification unit (104), a large speech element DB (105), a correspondence DB (106) that associates the small speech element DB (101) with the large speech element DB (105), a speech element candidate obtainment unit (107), a large speech element selection unit (108), and a large speech element concatenation unit (109). By editing synthetic speech using the small speech element DB (101) and performing quality enhancement on an editing result using the large speech element DB (105), speech content can be generated easily on a mobile terminal.

### TECHNICAL FIELD

The present invention relates to a speech content editing/generation method based on a speech synthesis technique.

### BACKGROUND ART

In recent years, the development of speech synthesis techniques has made it possible to generate synthetic speech of very high quality.

However, conventional uses of synthetic speech are mainly limited to uniform applications such as reading aloud news text in an announcer style.

On the other hand, mobile phone services and the like have begun to distribute characteristic speech (synthetic speech of high personal reproducibility or synthetic speech with distinctive prosody and voice quality such as a high-school girl style or a Kansai-dialect speaker style) as one kind of content by, for example, offering a service for using a voice message of a celebrity as a ring tone. To enhance the pleasure of interpersonal communication, demands to generate characteristic speech for the other party in communication to hear are likely to be on the increase.

This being so, there is a growing need to edit/generate and use speech content that is not limited to the conventional monotonous read-aloud style but has various voice quality and prosody features.

Here, to “edit/generate speech content” means, in terms of the aforementioned speech content generation, that an editor customizes synthetic speech to suit his/her own preferences by, for example, adding a distinctive intonation like a high-school girl or a Kansai-dialect speaker, changing prosody or voice quality so as to convey emotion, or emphasizing endings. Such customization is conducted by repeated editing and pre-listening, rather than by one process. As a result, content desired by the user can be generated.

An environment for easing the above speech content editing/generation has the following requirements.

(1) Synthetic speech can be generated even by a small hardware resource such as a mobile terminal.

(2) Synthetic speech can be edited at high speed.

(3) Synthetic speech during editing can be pre-listened easily.

Conventionally, a method for generating synthetic speech of high quality by selecting and concatenating an optimum speech element series from a speech database storing a large amount of speech with a total reproduction period of several hours to several hundred hours is proposed as a high-quality synthetic speech generation method (for example, see Patent Reference 1). FIG. 1 is a block diagram showing a structure of a conventional speech synthesizer disclosed in Patent Reference 1.

This conventional speech synthesizer is a speech synthesizer that receives an input of a synthesizer command 002 obtained as a result of analyzing text which is a synthesis target, selects appropriate speech elements from extended speech elements included in a speech element database (DB) 001, concatenates the selected speech elements, and outputs a synthetic speech waveform 019.

The speech synthesizer includes a multistage preliminary selection unit 003, a speech element selection unit 004, and a concatenation unit 005.

The multistage preliminary selection unit 003 receives the synthesizer command 002, and performs multistage preliminary selection on speech elements designated by the synthesizer command 002 to select a preliminary selection candidate group 018, as described later.

The speech element selection unit 004 receives the synthesizer command 002, and selects speech elements for which a cost computed using all sub-costs is minimum, from the preliminary selection candidate group 018.

The concatenation unit 005 concatenates the speech elements selected by the speech element selection unit 004, and outputs the synthetic speech waveform 019.

Note that, since the preliminary selection candidate group 018 is used only for selecting speech elements, the preliminary selection candidate group 018 only includes feature parameters necessary for cost computation and does not include speech element data themselves. The concatenation unit 005 obtains data of speech elements selected by the speech element selection unit 004 by referencing the speech element DB 001.

Sub-costs used in the conventional speech synthesizer include six types of sub-costs corresponding to a fundamental frequency error, a duration error, a Mel Frequency Cepstrum Coefficient (MFCC) error, a F0 (fundamental frequency) discontinuity error, a MFCC discontinuity error, and a phoneme environment error. Of these sub-costs, the former three sub-costs belong to a target cost, and the latter three sub-costs belong to a concatenation cost.

In the cost computation by the speech element selection unit 004 in the conventional speech synthesizer, costs are computed from sub-costs.

The multistage preliminary selection unit 003 includes four preliminary selection units 006, 009, 012, and 015.

The first preliminary selection unit 006 receives the synthesizer command 002, performs preliminary selection from speech element candidates in the speech element DB 001 according to the F0 error and the duration error at each time, and outputs a first candidate group 007.

The second preliminary selection unit 009 performs preliminary selection from speech elements in the first candidate group 007 according to the F0 error, the duration error, and the MFCC error at each time, and outputs a second candidate group 010.

Likewise, the third preliminary selection unit 012 and the fourth preliminary selection unit 015 each perform preliminary selection using part of the sub-costs.

As a result of performing preliminary selection in this way, an amount of computation for selecting optimum speech elements from the speech element DB 001 can be reduced. Patent Reference 1: Japanese Unexamined Patent Application Publication No. 2005-265895 (FIG. 1).

### DISCLOSURE OF INVENTION

### Problems that Invention is to Solve

As mentioned above, the present invention has an object of generating speech content, and this requires a means of editing synthetic speech. However, the following problems arise when editing synthetic speech, that is, speech content, by using the technique of Patent Reference 1.

The speech synthesizer disclosed in Patent Reference 1 can reduce the total computation cost by introducing the preliminary selection units in the selection of speech elements. However, in order for the speech synthesizer to eventually obtain synthetic speech, the first preliminary selection unit 006 needs to perform preliminary selection from all speech elements. Moreover, the concatenation unit 005 needs to obtain final optimum speech elements from the speech element DB 001 every time. Further, to generate high-quality synthetic speech, a large number of speech elements need to be stored in the speech element DB 001, typically making it a large database with a total reproduction period of several hours to several hundred hours.

Thus, in the case of selecting speech elements from the large speech element DB 001 when editing synthetic speech, it is necessary to search the entire large speech element DB 001 in each editing operation until the desired synthetic speech is eventually obtained. This causes a problem of a large computation cost in editing.

The present invention has been developed to solve the above conventional problems, and has an object of providing a speech synthesizer that can execute speech content editing at high speed and generate speech content easily.

### Means to Solve the Problems

A speech synthesizer according to an aspect of the present invention is a speech synthesizer that generates synthetic speech which conforms to phonetic symbols and prosody information, the speech synthesizer including: a small database holding pieces of synthetic speech generation data used for generating synthetic speech; a large database holding speech elements which are greater in number than the pieces of synthetic speech generation data held in the small database; a synthetic speech generation data selection unit that selects, from the small database, pieces of synthetic speech generation data from which synthetic speech that conforms to the phonetic symbols and the prosody information is to be generated; a correspondence database holding correspondence information that shows correspondences between the pieces of synthetic speech generation data held in the small database and the speech elements held in the large database; a conforming speech element selection unit that selects, from the large database, speech elements which correspond to the pieces of synthetic speech generation data selected by the synthetic speech generation data selection unit, using the correspondence information held in the correspondence database; and a speech element concatenation unit that generates synthetic speech by concatenating the speech elements selected by the conforming speech element selection unit.

According to this structure, the synthetic speech generation data selection unit selects pieces of synthetic speech generation data from the small database, and the conforming speech element selection unit selects high-quality speech elements corresponding to the selected pieces of synthetic speech generation data from the large database. By selecting speech elements in two stages in such a way, high-quality speech elements can be selected at high speed.

Moreover, the large database may be provided in a server that is connected to the speech synthesizer via a computer network, wherein the conforming speech element selection unit selects the speech elements from the large database provided in the server.

By providing the large database in the server, an unnecessary storage capacity of a terminal can be saved, and the speech synthesizer can be realized with a minimum structure.

Moreover, the speech synthesizer may further include: a small speech element concatenation unit that generates simple synthetic speech by concatenating speech elements that are the pieces of synthetic speech generation data selected by the synthetic speech generation data selection unit; and a prosody information modification unit that receives information for modifying prosody information of the simple synthetic speech and modifies the prosody information according to the received information, wherein the synthetic speech generation data selection unit, when the prosody information of the simple synthetic speech is modified, re-selects, from the small database, pieces of synthetic speech generation data from which synthetic speech that conforms to the phonetic symbols and the modified prosody information is to be generated, and outputs the re-selected pieces of synthetic speech generation data to the small speech element concatenation unit, and the conforming speech element selection unit receives the pieces of synthetic speech generation data determined as a result of the modification and the re-selection, and selects, from the large database, speech elements which correspond to the received pieces of synthetic speech generation data.

As a result of modifying prosody information, pieces of synthetic speech generation data are re-selected. Through repetitions of such modification of prosody information and re-selection of pieces of synthetic speech generation data, pieces of synthetic speech generation data desired by the user can be selected. In addition, the selection of speech elements from the large database needs to be performed only once at the end. Thus, high-quality synthetic speech can be generated efficiently.

Note that the present invention can be realized not only as a speech synthesizer including the above characteristic units, but also as a speech synthesis method including steps corresponding to the characteristic units included in the speech synthesizer, or a program causing a computer to execute the characteristic steps included in the speech synthesis method. Such a program can be distributed via a recording medium such as a Compact Disc-Read Only Memory (CD-ROM) or a communication network such as the Internet.

### EFFECTS OF THE INVENTION

According to the present invention, it is possible to provide a speech synthesizer that can execute speech content editing at high speed and generate speech content easily.

With the speech synthesizer according to the present invention, synthetic speech can be generated using a small database by a terminal alone, in a synthetic speech editing process. Moreover, the prosody modification unit allows the user to perform synthetic speech editing. This makes it possible to edit speech content even in a terminal with relatively small resources such as a mobile terminal. Further, since synthetic speech can be generated using the small database on the terminal side, the user can reproduce and pre-listen edited synthetic speech using only the terminal.

In addition, after the editing process is completed, the user can perform a quality enhancement process using a large database held in a server. Here, a correspondence database shows correspondences between an already determined small speech element series and candidates in the large database. Accordingly, the selection of speech elements by the large speech element selection unit can be made merely by searching a limited search space, as compared with the case of re-selecting speech elements once again. This contributes to a significant reduction in computation amount. For example, a system of several GB or more is used for large speech elements, while a system of about 0.5 MB is used for small speech elements.

Furthermore, the communication between the terminal and the server for obtaining speech elements stored in the large database needs to be performed only once, namely, at the time of the quality enhancement process. Hence a time loss associated with communication can be reduced. In other words, by separating the speech content editing process and the quality enhancement process, it is possible to improve responsiveness for the speech content editing process.

### BRIEF DESCRIPTION OF DRAWINGS

FIG. 1 is a block diagram showing a structure of a conventional multistage speech element selection-type speech synthesizer.

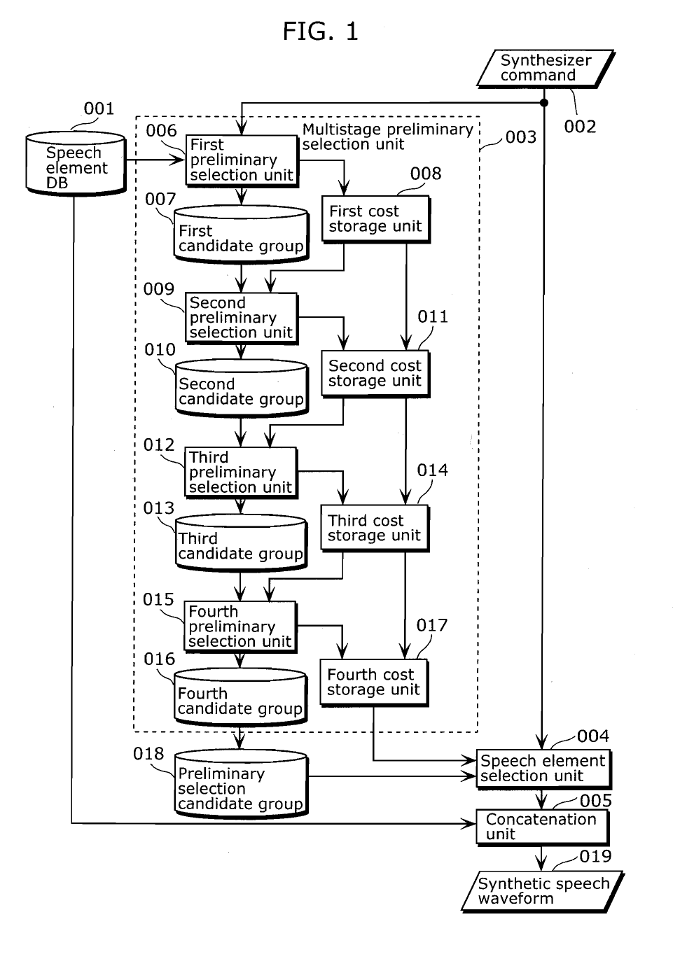

FIG. 2 is a block diagram showing a structure of a multiple quality speech synthesizer in a first embodiment of the present invention.

FIG. 3 shows an example of a correspondence DB in the first embodiment of the present invention.

FIG. 4 is a schematic diagram showing a case where the multiple quality speech synthesizer in the first embodiment of the present invention is realized as a system.

FIG. 5 is a flowchart showing an operation of the multiple quality speech synthesizer in the first embodiment of the present invention.

FIG. 6 shows an operation example of a quality enhancement process in the first embodiment of the present invention.

FIG. 7 is a schematic diagram showing a case where hierarchical clustering is performed on a speech element group held in a large speech element DB.

FIG. 8 is a flowchart showing a multiple quality speech synthesis process in a first variation of the first embodiment of the present invention.

FIG. 9 is a flowchart showing a multiple quality speech synthesis process in a second variation of the first embodiment of the present invention.

FIG. 10 is a flowchart showing a multiple quality speech synthesis process in a third variation of the first embodiment of the present invention.

FIG. 11 is a flowchart showing a multiple quality speech synthesis process in a fourth variation of the first embodiment of the present invention.

FIG. 12 is a block diagram showing a structure of a text-to-speech synthesizer using HMM speech synthesis which is a speech synthesis method based on statistical models.

FIG. 13 is a block diagram showing a structure of a multiple quality speech synthesizer in a second embodiment of the present invention.

FIG. 14 is a flowchart showing an operation of the multiple quality speech synthesizer in the second embodiment of the present invention.

FIG. 15 shows an operation example of a quality enhancement process in the second embodiment of the present invention.

FIG. 16 is a schematic diagram showing a case where context clustering is performed on a speech element group held in a large speech element DB.

FIG. 17 shows an example of a correspondence DB in the second embodiment of the present invention.

FIG. 18 shows an operation example when a plurality of states of an HMM are assigned in units of speech elements in the quality enhancement process in the second embodiment of the present invention.

FIG. 19 is a block diagram showing a structure of a multiple quality speech synthesis system in a third embodiment of the present invention.

FIG. 20 is a flowchart showing a flow of processing by the multiple quality speech synthesis system in the third embodiment of the present invention.

FIG. 21 is a flowchart showing the flow of processing by the multiple quality speech synthesis system in the third embodiment of the present invention.

### NUMERICAL REFERENCES

101 Small speech element DB
102 Small speech element selection unit
103 Small speech element concatenation unit
104 Prosody modification unit
105 Large speech element DB
106, 506 Correspondence DB
107 Speech element candidate obtainment unit
108 Large speech element selection unit
109 Large speech element concatenation unit
501 HMM model DB
502 HMM model selection unit
503 Synthesis unit

### BEST MODE FOR CARRYING OUT THE INVENTION

The following describes embodiments of the present invention with reference to drawings.

### First Embodiment

In a first embodiment of the present invention, a speech element DB is hierarchically organized into a small speech element DB and a large speech element DB to thereby increase efficiency of a speech content editing process.

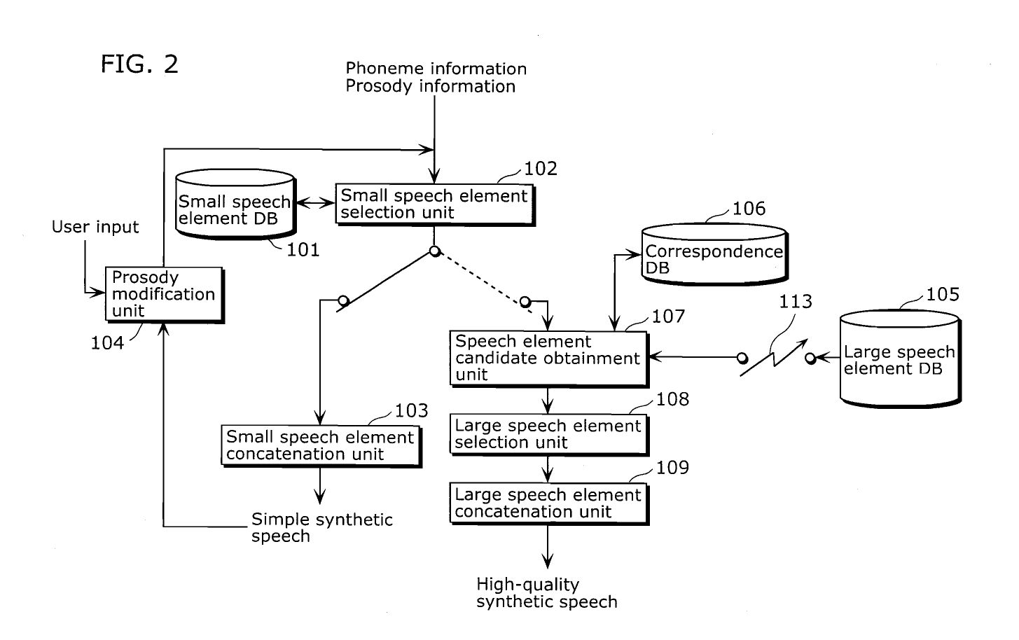

FIG. 2 is a block diagram showing a structure of a multiple quality speech synthesizer in the first embodiment of the present invention.

The multiple quality speech synthesizer is an apparatus that synthesizes speech in multiple qualities, and includes a small speech element DB 101, a small speech element selection unit 102, a small speech element concatenation unit 103, a prosody modification unit 104, a large speech element DB 105, a correspondence DB 106, a speech element candidate obtainment unit 107, a large speech element selection unit 108, and a large speech element concatenation unit 109.

The small speech element DB 101 is a database holding small speech elements. In this description, a speech element stored in the small speech element DB 101 is specifically referred to as a “small speech element”.

The small speech element selection unit 102 is a processing unit that receives an input of phoneme information and prosody information which are a target of synthetic speech to be generated, and selects an optimum speech element series from the speech elements held in the small speech element DB 101.

The small speech element concatenation unit 103 is a processing unit that concatenates the speech element series selected by the small speech element selection unit 102 to generate synthetic speech.

The prosody modification unit 104 is a processing unit that receives an input of information for modifying the prosody information from a user, and modifies the prosody information which is the target of synthetic speech to be generated by the multiple quality speech synthesizer.

The large speech element DB 105 is a database holding large speech elements. In this description, a speech element stored in the large speech element DB 105 is specifically referred to as a “large speech element”.

The correspondence DB 106 is a database holding information that shows correspondences between the speech elements held in the small speech element DB 101 and the speech elements held in the large speech element DB 105.

The speech element candidate obtainment unit 107 is a processing unit that receives an input of the speech element series selected by the small speech element selection unit 102 and, on the basis of the information about the speech element correspondences stored in the correspondence DB 106, obtains speech element candidates corresponding to each speech element in the inputted speech element series, from the large speech element DB 105 via a network 113 or the like.

The large speech element selection unit 108 is a processing unit that receives an input of the phoneme information and the prosody information which are the target of synthetic speech, namely, the phoneme information received by the small speech element selection unit 102 and the prosody information received by the small speech element selection unit 102 or modified by the prosody modification unit 104, and selects an optimum speech element series from the speech element candidates selected by the speech element candidate obtainment unit 107.

The large speech element concatenation unit 109 is a processing unit that concatenates the speech element series selected by the large speech element selection unit 108 to generate synthetic speech.

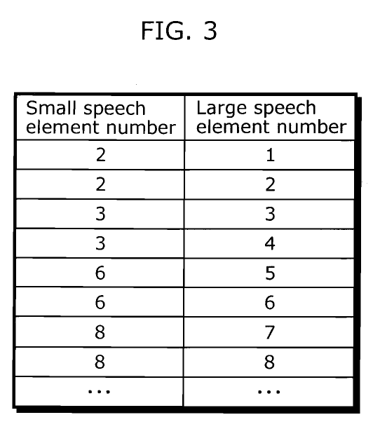

FIG. 3 shows an example of the information stored in the correspondence DB 106, which shows the correspondences between the speech elements held in the small speech element DB 101 and the speech elements held in the large speech element DB 105.

As shown in FIG. 3, the information showing the correspondences in the correspondence DB 106 associates “small speech element numbers” with “large speech element numbers”. A “small speech element number” is a speech element number for identifying a speech element stored in the small speech element DB 101, and a “large speech element number” is a speech element number for identifying a speech element stored in the large speech element DB 105. As one example, a speech element of a small speech element number “2” corresponds to speech elements of large speech element numbers “1” and “2”.

Note that the same speech element number indicates the same speech element. In detail, the speech element of the small speech element number “2” and the speech element of the large speech element number “2” are the same speech element.

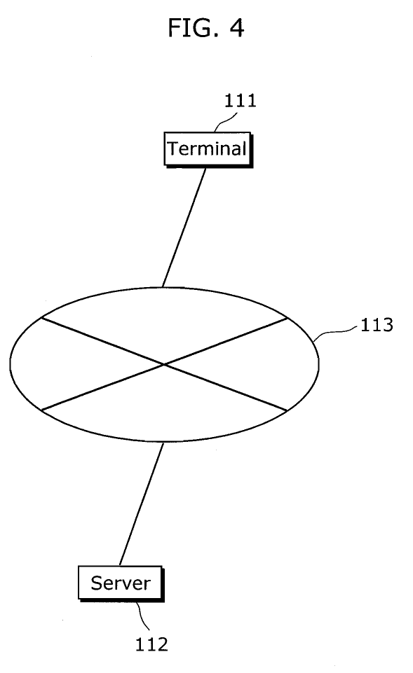

FIG. 4 is a schematic diagram showing a case where the multiple quality speech synthesizer in this embodiment is realized as a system.

The multiple quality speech synthesis system includes a terminal 111 and a server 112 that are connected to each other via the network 113, and realizes the multiple quality speech synthesizer through cooperative operations of the terminal 111 and the server 112.

The terminal 111 includes the small speech element DB 101, the small speech element selection unit 102, the small speech element concatenation unit 103, the prosody modification unit 104, the correspondence DB 106, the speech element candidate obtainment unit 107, the large speech element selection unit 108, and the large speech element concatenation unit 109. The server 112 includes the large speech element DB 105.

According to this structure of the multiple quality speech synthesis system, the terminal 111 is not required to have a large storage capacity. Moreover, the large speech element DB 105 does not need to be provided in the terminal 111, and can be held in the server 112 in a centralized manner.

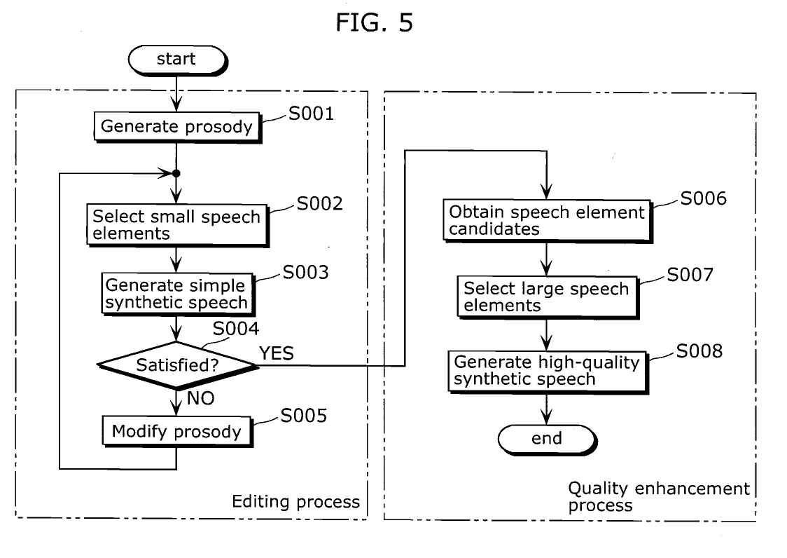

The following describes an operation of the multiple quality speech synthesizer in this embodiment, with reference to a flowchart shown in FIG. 5. The operation of the multiple quality speech synthesizer can be roughly divided into a process of editing synthetic speech and a process of enhancing the edited synthetic speech in quality. The synthetic speech editing process and the quality enhancement process are separately described below in sequence.

<Editing Process>

The synthetic speech editing process is described first. As preprocessing, text information inputted by the user is analyzed and prosody information is generated on the basis of a phoneme series and an accent mark (Step S001). A method of generating the prosody information is not specifically limited. For instance, the prosody information may be generated with reference to a template, or estimated using quantification theory type I. Alternatively, the prosody information may be directly inputted from outside.

As one example, text data (phoneme information) “arayuru” (“all”) is obtained and a prosody information group including each phoneme and prosody included in the phoneme information is outputted. This prosody information group at least includes prosody information t₁ showing a phoneme “a” and corresponding prosody, prosody information t₂ showing a phoneme “r” and corresponding prosody, prosody information t₃ showing a phoneme “a” and corresponding prosody, prosody information t₄ showing a phoneme “y” and corresponding prosody, and, in the same fashion, prosody information t₅, t₆, and t₇ respectively corresponding to phonemes “u”, “r”, and “u”.

The small speech element selection unit 102 selects an optimum speech element series (U=u₁, u₂, . . . , uₙ) from the small speech element DB 101 on the basis of the prosody information t₁ to t₇ obtained in Step S001, in consideration of distances (target cost (Ct)) from the target prosody (t₁ to t₇) and concatenability (concatenation cost (Cc)) of speech elements (Step S002). In more detail, the small speech element selection unit 102 searches for a speech element series for which a cost shown by the following Expression (1) is minimum, by the Viterbi algorithm. Methods of computing the target cost and the concatenation cost are not specifically limited. For example, the target cost may be computed using a weighting addition of differences of prosody information (fundamental frequency, duration, power), and the concatenation cost may be computed using a cepstrum distance between the end of uᵢ₋₁ and the beginning of uᵢ.

$$\begin{matrix}[ Expression 1 ] & \\ U = {arg min}_{U} [ {\sum }_{i = 1 , 2 , … , n} \{ Ct ( {t}_{i} , {u}_{i} ) + Cc ( {u}_{i} , {u}_{i - 1} ) \} ] & ( 1 ) \\ {arg min}_{U} [ ] & [ Expression 2 ] \end{matrix}$$

Expression 2 indicates such a series U that has a minimum value within the brackets, when U=u₁, u₂, . . . , uₙ is varied.

The small speech element concatenation unit 103 synthesizes a speech waveform using the speech element series selected by the small speech element selection unit 102, and presents synthetic speech to the user by outputting the synthetic speech (Step S003). A method of synthesizing the speech waveform is not specifically limited.

The prosody modification unit 104 receives an input of whether or not the user is satisfied with the synthetic speech (Step S004). When the user is satisfied with the synthetic speech (Step S004: YES), the editing process is completed and the process from Step S006 onward is executed.

When the user is not satisfied with the synthetic speech (Step S004: NO), the prosody modification unit 104 receives an input of information for modifying the prosody information from the user, and modifies the prosody information as the target (Step S005). For example, “modification of prosody information” includes a change in accent position, a change in fundamental frequency, a change in duration, and the like. In this way, the user can modify an unsatisfactory part of the prosody of the synthetic speech, and generate edited prosody information T′=t′₁, t′₂, . . . , t′ₙ. After the modification ends, the operation returns to Step S002. By repeating the process from Steps S002 to S005, synthetic speech of prosody desired by the user can be generated. A speech element series selected as a result of this is denoted by S=s₁, s₂, . . . , sₙ.

Note that an interface for the prosody modification unit 104 is not specifically limited. For instance, the user may modify prosody information using a slider or the like, or designate prosody information that is expressed intuitively such as a high-school girl style or a Kansai-dialect speaker style. Furthermore, the user may input prosody information by voice.

<Quality Enhancement Process>

A flow of the quality enhancement process is described next.

The speech element candidate obtainment unit 107 obtains speech element candidates from the large speech element DB 105, on the basis of the speech element series (S=s₁, s₂, . . . , sₙ) last determined in the editing process (Step S006). In detail, the speech element candidate obtainment unit 107 obtains speech element candidates corresponding to each speech element in the speech element series (S=s₁, s₂, . . . , sₙ) from the large speech element DB 105, by referencing the correspondence DB 106 which holds the information showing the correspondences between the speech elements held in the small speech element DB 101 and the speech elements held in the large speech element DB 105. A method of generating the correspondence DB 106 will be described later.

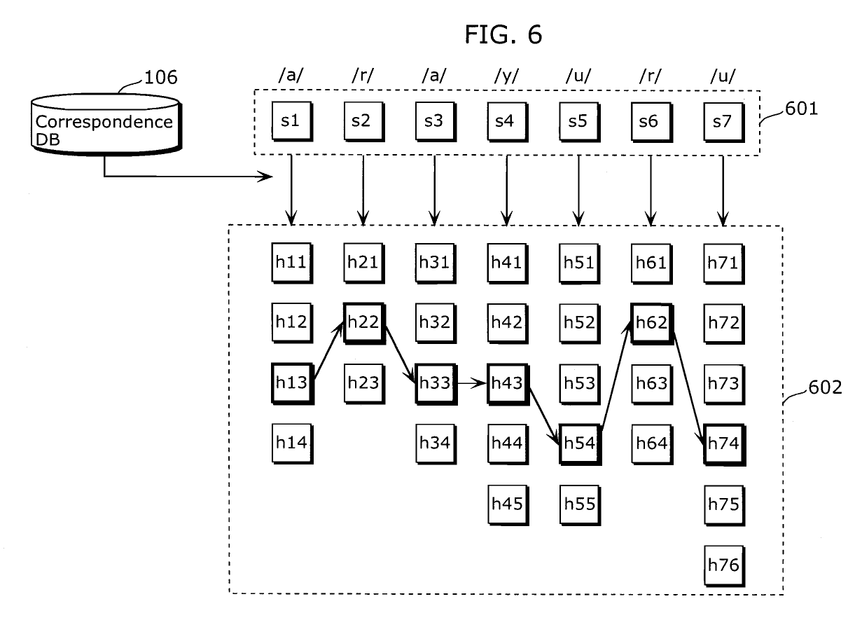

The speech element candidate obtainment process (Step S006) by the speech element candidate obtainment unit 107 is described in detail below, with reference to FIG. 6. In FIG. 6, a part enclosed by a dashed box 601 indicates the speech element series (S=s₁, s₂ . . . , s₇) in the small speech element DB 101, which is determined for the phoneme sequence “arayuru” in the editing process (Steps S001 to S005). FIG. 6 shows a situation where a speech element candidate group corresponding to each small speech element (sᵢ) is obtained from the large speech element DB 105 according to the correspondence DB 106. In FIG. 6, for example, the small speech element s₁ which is determined as the phoneme “a” in the editing process can be expanded to a large speech element group h₁₁, h₁₂, h₁₃, h₁₄ according to the correspondence DB 106. In other words, the large speech element group h₁₁, h₁₂, h₁₃, h₁₄ is a plurality of actual speech waveforms (or analytical parameters based on the actual speech waveforms) that are acoustically similar to the small speech element s₁.

Likewise, the small speech element S2 corresponding to the phoneme “r” can be expanded to a large speech element group h₂₁, h₂₂, h₂₃ according to the correspondence DB 106. In the same manner, speech element candidates corresponding to each of s₃, . . . , s₇ can be obtained according to the correspondence DB 106. A large speech element candidate group series 602 shown in FIG. 6 indicates a series of large speech element candidate groups corresponding to the small speech element series S.

The large speech element selection unit 108 selects a speech element series optimum for the prosody information edited by the user, from the above large speech element candidate group series 602 (Step S007). A method of the selection may be the same as Step S002, and so its explanation has not been repeated here. In the example of FIG. 6, H=h₁₃, h₂₂, h₃₃, h₄₃, h₅₄, h₆₂, h₇₄ is selected from the large speech element candidate group series 602.

Thus, H=h₁₃, h₂₂, h₃₃, h₄₃, h₅₄, h₆₂, h₇₄ is selected from the speech element group held in the large speech element DB 105 as an optimum speech element series for realizing the prosody information edited by the user.

The large speech element concatenation unit 109 concatenates the speech element series H which is held in the large speech element DB 105 and selected in Step S007, to generate synthetic speech (Step S008). A method of the concatenation is not specifically limited.

Note that before concatenating the speech elements, each speech element may be modified according to need.

As a result of the above process, high-quality synthetic speech that is similar in prosody and voice quality to the simple synthetic speech edited in the editing process can be generated.

<Correspondence DB Generation Method>

The following describes the correspondence DB 106 in more detail.

As mentioned earlier, the correspondence DB 106 is a database that holds information showing the correspondences between the speech elements held in the small speech element DB 101 and the speech elements held in the large speech element DB 105.

In detail, the correspondence DB 106 is used to select speech elements similar to the simple synthetic speech generated in the editing process from the large speech element DB 105, in the quality enhancement process.

The small speech element DB 101 is a subset of the speech element group held in the large speech element DB 105, and satisfies the following relation, which is a feature of the present invention.

First, each speech element held in the small speech element DB 101 is associated with one or more speech elements held in the large speech element DB 105. The one or more speech elements in the large speech element DB 105 which are associated by the correspondence DB 106 are acoustically similar to the speech element in the small speech element DB 101. Criteria for this similarity include prosody information (fundamental frequency, power information, duration, and the like) and vocal tract information (formant, cepstrum coefficient, and the like).

Accordingly, speech elements that are similar in prosody and voice quality to the simple synthetic speech generated using the speech element series held in the small speech element DB 101 can be selected in the quality enhancement process. In addition, in the case of the large speech element DB 105, optimum speech element candidates can be selected from a wide choice of candidates. This allows for a reduction in cost when the above large speech element selection unit 108 selects speech elements. As a result, the effect of enhancing synthetic speech in quality can be attained.

A reason for this is given below. The small speech element DB 101 only holds limited speech elements. Therefore, though it is possible to generate synthetic speech close to the target prosody, high concatenability between speech elements cannot be ensured. On the other hand, the large speech element DB 105 is capable of holding a large amount of data. Accordingly, the large speech element selection unit 108 can select a speech element series having high concatenability from the large speech element DB 105 (for example, this can be achieved by using the method disclosed in Patent Reference 1).

A technique of clustering is employed to make the above association. “Clustering” is a method of classifying objects into groups on the basis of an index of similarity between objects which is determined by a plurality of traits.

There are mainly two types of clustering: a hierarchical clustering method of merging similar objects into a same group; and a non-hierarchical clustering method of dividing the whole set as a result of which similar objects belong to a same group. This embodiment is not limited to a particular clustering method, so long as similar speech elements will end up belonging to a same group. For instance, “hierarchical clustering using a heap” is a known hierarchical clustering method, and “k-means clustering” is a known non-hierarchical clustering method.

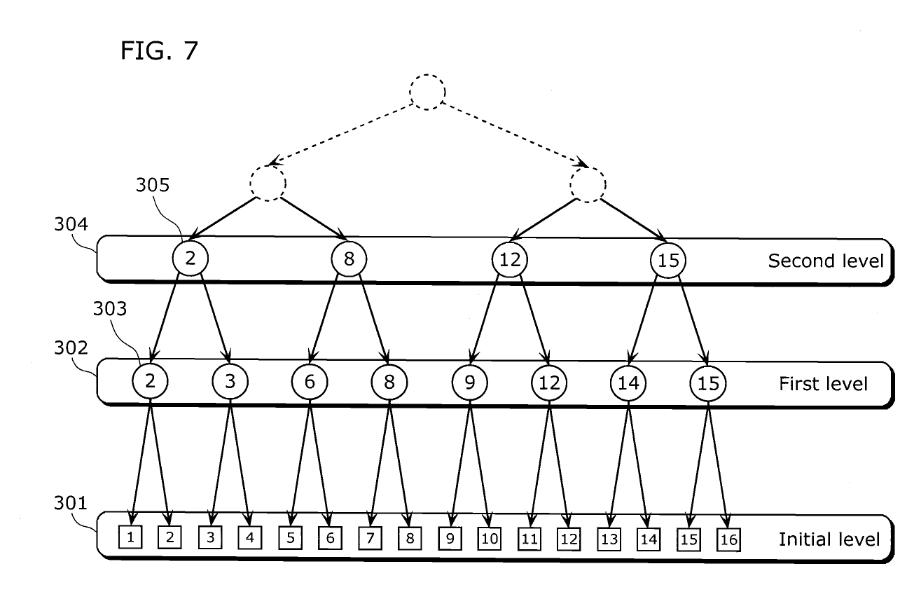

A method of merging speech elements into groups according to hierarchical clustering is described first. FIG. 7 is a schematic diagram showing a case where hierarchical clustering is performed on the speech element group held in the large speech element DB 105.

An initial level 301 includes each individual speech element held in the large speech element DB 105. In the example of FIG. 7, each speech element held in the large speech element DB 105 is shown by a rectangle, and a number within the rectangle is an identifier of the speech element, that is, a speech element number.

A first-level cluster group 302 is a set of clusters generated as a first level according to hierarchical clustering. Each cluster is shown by a circle. A cluster 303 is one of the clusters in the first level, and is made up of speech elements of speech element numbers “1” and “2”. A number shown for each cluster is an identifier of a speech element representative of the cluster. As one example, a speech element representative of the cluster 303 is the speech element of the speech element number “2”. Here, it is necessary to determine, for each cluster, a representative speech element which represents the cluster. This representative speech element determination may be made by a method of using a centroid of a speech element group which belongs to a cluster. That is, a speech element nearest a centroid of a speech element group which belongs to a cluster is determined as a representative of the cluster. In the example of FIG. 7, the speech element representative of the cluster 303 is the speech element of the speech element number “2”. Representative speech elements of the other clusters can be determined in the same manner.

A centroid of a speech element group belonging to a cluster is computed as follows. Given a vector composed of prosody information and vocal tract information of each speech element included in the speech element group, a barycenter of a plurality of vectors in a vector space is determined as the centroid of the cluster.

Moreover, a representative speech element is computed by calculating similarity between the vector of each speech element included in the speech element group and a vector of the centroid of the cluster and determining a speech element having maximum similarity as the representative speech element. Here, a distance (e.g. Euclidean distance) between the vector of each speech element and the vector of the centroid of the cluster may be computed to determine a speech element having a minimum distance as the representative speech element.

A second-level cluster group 304 is generated by further clustering the clusters which belong to the first-level cluster group 302, according to the above similarity. This being so, the number of clusters in the second-level cluster group 304 is smaller than the number of clusters in the first-level cluster group 302. A representative speech element of a cluster 305 in the second level can be determined in the same way as above. In the example of FIG. 7, the speech element of the speech element number “2” is representative of the cluster 305.

By performing such hierarchical clustering, the large speech element DB 105 can be divided as the first-level cluster group 302 or the second-level cluster group 304.

Here, a speech element group made up of only representative speech elements of clusters in the first-level cluster group 302 can be used as the small speech element DB 101. In the example of FIG. 7, speech elements of speech element numbers “2”, “3”, “6”, “8”, “9”, “12”, “14”, and “15” can be used as the small speech element DB 101. Likewise, a speech element group made up of only representative speech elements of clusters in the second-level cluster group 304 can be used as the small speech element DB 101. In the example of FIG. 7, speech elements of speech element numbers “2”, “8”, “12”, and “15” can be used as the small speech element DB 101.

By utilizing such relation, it is possible to build the correspondence DB 106 shown in FIG. 3.

In the example of FIG. 3, the first-level cluster group 302 is used as small speech elements. The speech element of the small speech element number “2” is associated with the speech elements of the large speech element numbers “1” and “2” in the large speech element DB 105. The speech element of the small speech element number “3” is associated with the speech elements of the large speech element numbers “3” and “4” in the large speech element DB 105. In this way, all representative speech elements in the first-level cluster group 302 can be associated with the large speech element numbers in the large speech element DB 105. By associating the small speech element numbers with the large speech element numbers and holding their relations as a table beforehand, it is possible to reference the correspondence DB 106 at extremely high speed.

The above hierarchical clustering allows the small speech element DB 101 to be changed in size. In more detail, it is possible to use the representative speech elements in the first-level cluster group 302 or the representative speech elements in the second-level cluster group 304, as the small speech element DB 101. Hence the small speech element DB 101 can be generated in accordance with the storage capacity of the terminal 111.

Here, the small speech element DB 101 and the large speech element DB 105 satisfy the above relation. Which is to say, in the case where the representative speech elements in the first-level cluster group 302 are used as the small speech element DB 101, for example the speech element of the speech element number “2” held in the small speech element DB 101 corresponds to the speech elements of the speech element numbers “1” and “2” held in the large speech element DB 105. These speech elements of the speech element numbers “1” and “2” are similar to the representative speech element of the speech element number “2” in the cluster 303, according to the above criteria.

Suppose the small speech element selection unit 102 selects the speech element of the speech element number “2” from the small speech element DB 101. In this case, the speech element candidate obtainment unit 107 obtains the speech elements of the speech element numbers “1” and “2” with reference to the correspondence DB 106. The large speech element selection unit 108 selects a candidate for which the above Expression (1) yields a minimum value, that is, a speech element that is closer to the target prosody and has higher concatenability with preceding and succeeding speech elements, from the obtained speech element candidates.

Thus, it can be ensured that a cost of the speech element series selected by the large speech element selection unit 108 is no higher than a cost of the speech element series selected by the small speech element selection unit 102. This is because the speech element candidates obtained by the speech element candidate obtainment unit 107 include the speech elements selected by the small speech element selection unit 102 and additionally include the speech elements similar to the speech elements selected by the small speech element selection unit 102.

Though the above describes the case where the correspondence DB 106 is formed by hierarchical clustering, the correspondence DB 106 may also be formed by non-hierarchical clustering.

K-means clustering may be used as one example. K-means clustering is non-hierarchical clustering that divides an object group (a speech element group in this embodiment) into the number of clusters (k) which has been set beforehand. K-means clustering allows the size of the small speech element DB 101 required of the terminal 111 to be computed at the time of design. Moreover, by determining a representative speech element for each of the k clusters generated by division and using these representative speech elements as the small speech element DB 101, the same effect as hierarchical clustering can be attained.

Note that the above clustering process can be conducted efficiently by clustering per unit of a speech element (for example, phoneme, syllable, mora, CV (C: consonant, V: vowel), VCV) which has been set beforehand.

According to the above structure, the terminal 111 includes the small speech element DB 101, the small speech element selection unit 102, the small speech element concatenation unit 103, the prosody modification unit 104, the correspondence DB 106, the speech element candidate obtainment unit 107, the large speech element selection unit 108, and the large speech element concatenation unit 109, and the server 112 includes the large speech element DB 105. Thus, the terminal 111 is not required to have a large storage capacity. Moreover, since the large speech element DB 105 can be held in the server 112 in a centralized manner, it is sufficient to hold only one large speech element DB 105 in the server 112 even in the case where there are two or more terminals 111.

For the editing process, synthetic speech can be generated using the small speech element DB 101 by the terminal 111 alone. In addition, the prosody modification unit 104 allows the user to perform synthetic speech editing.

Furthermore, after the editing process is completed, the quality enhancement process can be performed using the large speech element DB 105 held in the server 112. Here, the correspondence DB 106 shows the correspondences between an already determined small speech element series and candidates in the large speech element DB 105. Accordingly, the selection of speech elements by the large speech element selection unit 108 can be performed just by searching a limited search space. This contributes to a significant reduction in computation amount, when compared with the case of re-selecting speech elements once again.

Moreover, the communication between the terminal 111 and the server 112 needs to be performed only once, namely, at the time of the quality enhancement process. Hence a time loss associated with communication can be reduced. In other words, by separating the speech content editing process and the quality enhancement process, it is possible to improve responsiveness for the speech content editing process. Here, the server 112 may perform the quality enhancement process and transmit a quality enhancement result to the terminal 111 via the network 113.

This embodiment describes the case where the small speech element DB 101 is a subset of the large speech element DB 105, but the small speech element DB 101 may instead be generated by compressing the information in the large speech element DB 105. Such compression can be performed by decreasing a sampling frequency, decreasing a quantization bit rate, lowering an analysis order at the time of analysis, and the like. In this case, the correspondence DB 106 may show a one-to-one correspondence between the small speech element DB 101 and the large speech element DB 105.

Loads of the terminal and the server vary depending on how the structural components of this embodiment are divided between the terminal and the server. The information communicated between the terminal and the server also varies due to this, and so does the amount of communication. The following describes combinations of the structural components and their effects.

(Variation 1)

In this variation, the terminal 111 includes the small speech element DB 101, the small speech element selection unit 102, the small speech element concatenation unit 103, and the prosody modification unit 104, whereas the server 112 includes the large speech element DB 105, the correspondence DB 106, the speech element candidate obtainment unit 107, the large speech element selection unit 108, and the large speech element concatenation unit 109.

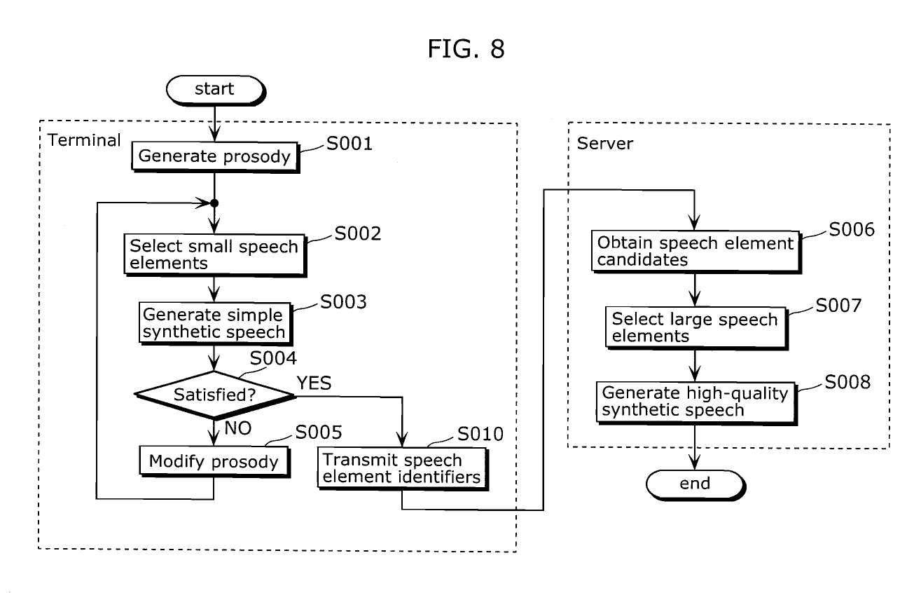

An operation of this variation is described below, with reference to a flowchart shown in FIG. 8. Since the individual steps have already been described above, their detailed explanation has not been repeated here.

The editing process is performed by the terminal 111. In detail, prosody information is generated (Step S001). Next, the small speech element selection unit 102 selects a small speech element series from the small speech element DB 101 (Step S002). The small speech element concatenation unit 103 concatenates the small speech elements to generate simple synthetic speech (Step S003). The user listens to the generated synthetic speech, and judges whether or not the user is satisfied with the simple synthetic speech (Step S004). When the user is not satisfied with the simple synthetic speech (Step S004: NO), the prosody modification unit 104 modifies the prosody information (Step S005). By repeating the process from Steps S002 to S005, desired synthetic speech is generated.

When the user is satisfied with the simple synthetic speech (Step S004: YES), the terminal 111 transmits identifiers of the small speech element series selected in Step S002 and the determined prosody information, to the server 112 (Step S010).

An operation on the server side is described next. The speech element candidate obtainment unit 107 references the correspondence DB 106 and obtains a speech element group which serves as selection candidates from the large speech element DB 105, on the basis of the identifiers of the small speech element series received from the terminal 111 (Step S006). The large speech element selection unit 108 selects an optimum large speech element series from the obtained speech element candidate group, according to the prosody information received from the terminal 111 (Step S007). The large speech element concatenation unit 109 concatenates the selected large speech element series to generate high-quality synthetic speech (Step S008).

The server 112 transmits such generated high-quality synthetic speech to the terminal 111. As a result of the above process, high-quality synthetic speech can be generated.

According to the above structures of the terminal 111 and the server 112, the terminal 111 can be realized with only the small speech element DB 101, the small speech element selection unit 102, the small speech element concatenation unit 103, and the prosody modification unit 104. Hence its memory capacity requirement can be reduced. Moreover, since the terminal 111 generates synthetic speech using only small speech elements, the amount of computation can be reduced. Furthermore, the information communicated from the terminal 111 to the server 112 is only the prosody information and the identifiers of the small speech element series, with it being possible to significantly reduce the amount of communication. In addition, the communication from the server 112 to the terminal 111 needs to be performed only once when transmitting the high-quality synthetic speech, which also contributes to a smaller amount of communication.

(Variation 2)

In this variation, the terminal 111 includes the small speech element DB 101, the small speech element selection unit 102, the small speech element concatenation unit 103, the prosody modification unit 104, the correspondence DB 106, and the speech element candidate obtainment unit 107, whereas the server 112 includes the large speech element DB 105, the large speech element selection unit 108, and the large speech element concatenation unit 109.

This variation differs from variation 1 in that the correspondence DB 106 is included in the terminal 111.

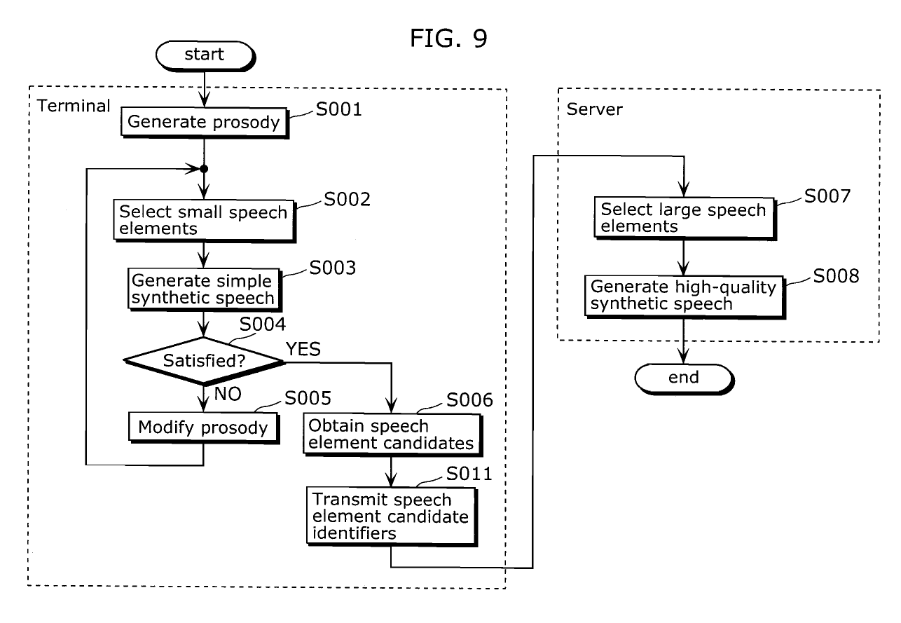

An operation of this variation is described below, with reference to a flowchart shown in FIG. 9. Since the individual steps have already been described above, their detailed explanation has not been repeated here.

The editing process is performed by the terminal 111. In detail, prosody information is generated (Step S001). Next, the small speech element selection unit 102 selects a small speech element series from the small speech element DB 101 (Step S002). The small speech element concatenation unit 103 concatenates the small speech elements to generate simple synthetic speech (Step S003). The user listens to the generated synthetic speech, and judges whether or not the user is satisfied with the simple synthetic speech (Step S004). When the user is not satisfied with the simple synthetic speech (Step S004: NO), the prosody modification unit 104 modifies the prosody information (Step S005). By repeating the process from Steps S002 to S005, desired synthetic speech is generated.

When the user is satisfied with the simple synthetic speech (Step S004: YES), the speech element candidate obtainment unit 107 obtains speech element identifiers of corresponding candidates in the large speech element DB 105, with reference to the correspondence DB 106 (Step S006). The terminal 111 transmits the identifiers of the large speech element candidate group and the determined prosody information to the server 112 (Step S011).

An operation on the server side is described next. The large speech element selection unit 108 selects an optimum large speech element series from the obtained speech element candidate group, according to the prosody information received from the terminal 111 (Step S007). The large speech element concatenation unit 109 concatenates the selected large speech element series to generate high-quality synthetic speech (Step S008).

The server 112 transmits such generated high-quality synthetic speech to the terminal 111. As a result of the above process, high-quality synthetic speech can be generated.

According to the above structures of the terminal 111 and the server 112, the terminal 111 can be realized with only the small speech element DB 101, the small speech element selection unit 102, the small speech element concatenation unit 103, the prosody modification unit 104, the correspondence DB 106, and the speech element candidate obtainment unit 107. Hence its memory capacity requirement can be reduced. Moreover, since the terminal 111 generates synthetic speech using only small speech elements, the amount of computation can be reduced. Furthermore, the correspondence DB 106 is included in the terminal 111, which alleviates the processing of the server 112. In addition, the information communicated from the terminal 111 to the server 112 is only the prosody information and the identifiers of the speech element candidate group. Since the speech element candidate group can be notified just by transmitting identifiers, the amount of communication can be reduced significantly. Meanwhile, the server 112 does not need to perform the process of obtaining the speech element candidates, with it being possible to lighten a processing load on the server 112. Moreover, the communication from the server 112 to the terminal 111 needs to be performed only once when transmitting the high-quality synthetic speech, which also contributes to a smaller amount of communication.

(Variation 3)

In this variation, the terminal 111 includes the small speech element DB 101, the small speech element selection unit 102, the small speech element concatenation unit 103, the prosody modification unit 104, the correspondence DB 106, the speech element candidate obtainment unit 107, the large speech element selection unit 108, and the large speech element concatenation unit 109, whereas the server 112 includes the large speech element DB 105.

This variation differs from variation 2 in that the large speech element selection unit 108 and the large speech element concatenation unit 109 are included in the terminal 111.

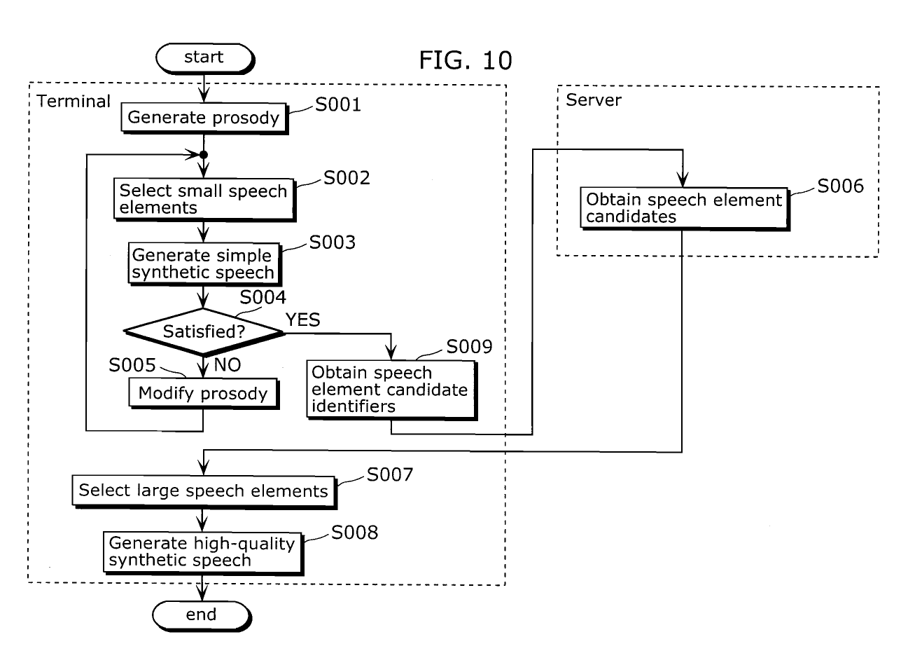

An operation of this variation is described below, with reference to a flowchart shown in FIG. 10. Since the individual steps have already been described above, their detailed explanation has not been repeated here.

The editing process is performed by the terminal 111. In detail, prosody information is generated (Step S001). Next, the small speech element selection unit 102 selects a small speech element series from the small speech element DB 101 (Step S002). The small speech element concatenation unit 103 concatenates the small speech elements to generate simple synthetic speech (Step S003). The user listens to the generated synthetic speech, and judges whether or not the user is satisfied with the simple synthetic speech (Step S004). When the user is not satisfied with the simple synthetic speech (Step S004: NO), the prosody modification unit 104 modifies the prosody information (Step S005). By repeating the process from Steps S002 to S005, desired synthetic speech is generated.

When the user is satisfied with the simple synthetic speech (Step S004: YES), the terminal 111 obtains speech element identifiers of corresponding candidates in the large speech element DB 105 with reference to the correspondence DB 106, and transmits the identifiers of the large speech element candidate group to the server 112 (Step S009).

An operation on the server side is described next. The server 112 selects the speech element candidate group from the large speech element DB 105 on the basis of the received identifiers of the candidate group, and transmits the speech element candidate group to the terminal 111 (Step S006).

In the terminal 111, the large speech element selection unit 108 computes an optimum large speech element series from the obtained speech element candidate group, according to the determined prosody information (Step S007).

The large speech element concatenation unit 109 concatenates the selected large speech element series to generate high-quality synthetic speech (Step S008).

According to the above structures of the terminal 111 and the server 112, the server 112 only needs to transmit the speech element candidates to the terminal 111 on the basis of the identifiers of the speech element candidates received from the terminal 111, so that a computation load of the server 112 can be lightened significantly. Moreover, since the terminal 111 selects the optimum speech element series from the limited speech element candidate group corresponding to the small speech elements in accordance with the correspondence DB 106, the selection of the optimum speech element series can be made with a relatively small amount of computation.

(Variation 4)

In this variation, the terminal 111 includes the small speech element DB 101, the small speech element selection unit 102, the small speech element concatenation unit 103, the prosody modification unit 104, the large speech element selection unit 108, and the large speech element concatenation unit 109, whereas the server 112 includes the large speech element DB 105, the correspondence DB 106, and the speech element candidate obtainment unit 107.

This variation differs from variation 3 in that the correspondence DB 106 is included in the server 112.

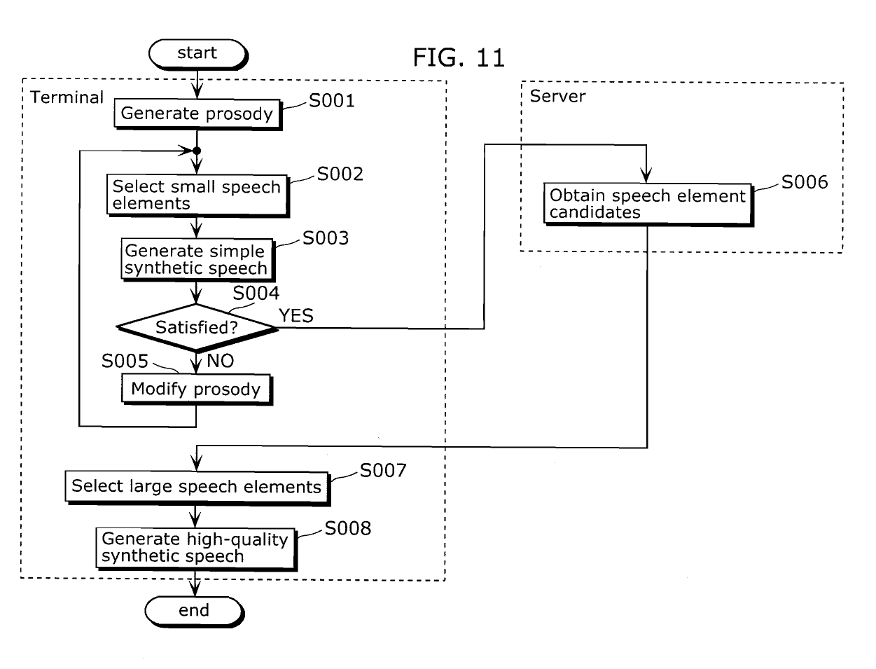

An operation of this variation is described below, with reference to a flowchart shown in FIG. 11. Since the individual steps have already been described above, their detailed explanation has not been repeated here.

The editing process is performed by the terminal 111. In detail, prosody information is generated (Step S001). Next, the small speech element selection unit 102 selects a small speech element series from the small speech element DB 101 (Step S002). The small speech element concatenation unit 103 concatenates the small speech elements to generate simple synthetic speech (Step S003). The user listens to the generated synthetic speech, and judges whether or not the user is satisfied with the simple synthetic speech (Step S004). When the user is not satisfied with the simple synthetic speech (Step S004: NO), the prosody modification unit 104 modifies the prosody information (Step S005). By repeating the process from Steps S002 to S005, desired synthetic speech is generated.

When the user is satisfied with the simple synthetic speech (Step S004: YES), processing control is transferred to the server 112.

The server 112 obtains a speech element group as corresponding candidates in the large speech element DB 105 with reference to the correspondence DB 106, and transmits the large speech element candidate group to the terminal 111 (Step S006).

After the terminal 111 receives the speech element candidate group, the large speech element selection unit 108 computes an optimum large speech element series from the obtained speech element candidate group, according to the determined prosody information (Step S007).

The large speech element concatenation unit 109 concatenates the selected large speech element series to generate high-quality synthetic speech (Step S008).

According to the above structures of the terminal 111 and the server 112, the server 112 only needs to receive the identifiers of the small speech element series and transmits the corresponding speech element candidate group in the large speech element DB 105 to the terminal 111 with reference to the correspondence DB 106, so that a computation load of the server 112 can be lightened significantly. Moreover, when compared with variation 3, the communication from the terminal 111 to the server 112 is only the transmission of the identifiers of the small speech element series, with it being possible to reduce the amount of communication.

### Second Embodiment

The following describes a multiple quality speech synthesizer in a second embodiment of the present invention.

The first embodiment describes the case where synthetic speech is generated in the editing process by concatenating a speech element series. The second embodiment differs from the first embodiment in that synthetic speech is generated according to hidden Markov model (HMM) speech synthesis. HMM speech synthesis is a method of speech synthesis based on statistical models, and has advantages that statistical models are compact and synthetic speech of stable quality can be generated. Since HMM speech synthesis is a known technique, its detailed explanation has been omitted here.

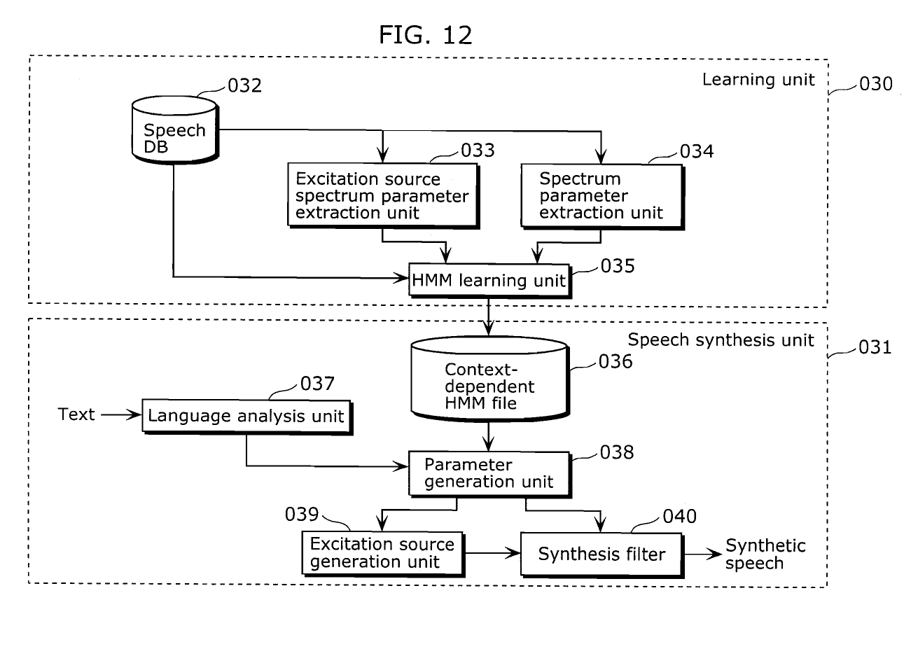

FIG. 12 is a block diagram showing a structure of a text-to-speech synthesizer using HMM speech synthesis which is a speech synthesis method based on statistical models (reference material: Japanese Unexamined Patent Application Publication No. 2002-268660).

The text-to-speech synthesizer includes a learning unit 030 and a speech synthesis unit 031.

The learning unit 030 includes a speech database (DB) 032, an excitation source spectrum parameter extraction unit 033, a spectrum parameter extraction unit 034, and an HMM learning unit 035. The speech synthesis unit 031 includes a context-dependent HMM file 036, a language analysis unit 037, a parameter generation unit 038, an excitation source generation unit 039, and a synthesis filter 040.

The learning unit 030 has a function of learning the context-dependent HMM file 036 using speech information stored in the speech DB 032. A large number of pieces of speech information, which have been prepared as samples beforehand, are stored in the speech DB 032. Speech information is obtained by adding, to a speech signal, label information (such as “arayuru” or “nuuyooku” (“New York”)) for identifying parts, such as phonemes, of a waveform.

The excitation source spectrum parameter extraction unit 033 and the spectrum parameter extraction unit 034 respectively extract an excitation source parameter sequence and a spectrum parameter sequence, for each speech signal retrieved from the speech DB 032. The HMM learning unit 035 performs an HMM learning process on the extracted excitation source parameter sequence and spectrum parameter sequence, using label information and time information retrieved from the speech DB 032 together with the speech signal. The learned HMM is stored in the context-dependent HMM file 036.

Parameters of an excitation source model are learned using a multi-space distribution HMM. The multi-space distribution HMM is an extended HMM that allows a dimension of a parameter vector to be different each time, and a pitch including a voiced/unvoiced flag is an example of a parameter sequence with such variable dimensions. In other words, a parameter vector is one-dimensional when voiced, and zero-dimensional when unvoiced. The learning unit 030 performs learning according to this multi-space distribution HMM. Specific examples of “label information” are given below. Each HMM holds these as attribute names (contexts).
phoneme (preceding, current, succeeding)
mora position of current phoneme within accent phrase
part of speech, conjugate form, conjugate type (preceding, current, succeeding)
mora length and accent type of accent phrase (preceding, current, succeeding)
position of current accent phrase and a pause or lack thereof before and after
mora length of breath group (preceding, current, succeeding)
position of current breath group
mora length of sentence

Such HMMs are called context-dependent HMMs.

The speech synthesis unit 031 has a function of generating a read-aloud type speech signal sequence from arbitrary electronic text. The language analysis unit 037 analyzes inputted text and converts the inputted text to label information which is a sequence of phonemes. The parameter generation unit 038 searches the context-dependent HMM file 036 on the basis of the label information, and concatenates obtained context-dependent HMMs to form a sentence HMM. The parameter generation unit 038 further generates an excitation source parameter sequence and a spectrum parameter sequence from the obtained sentence HMM, according to a parameter generation algorithm. The excitation source generation unit 039 and the synthesis filter 040 generate synthetic speech on the basis of the excitation source parameter sequence and the spectrum parameter sequence.

According to the above structure of the text-to-speech synthesizer, stable synthetic speech based on statistical models can be generated in the HMM speech synthesis process.

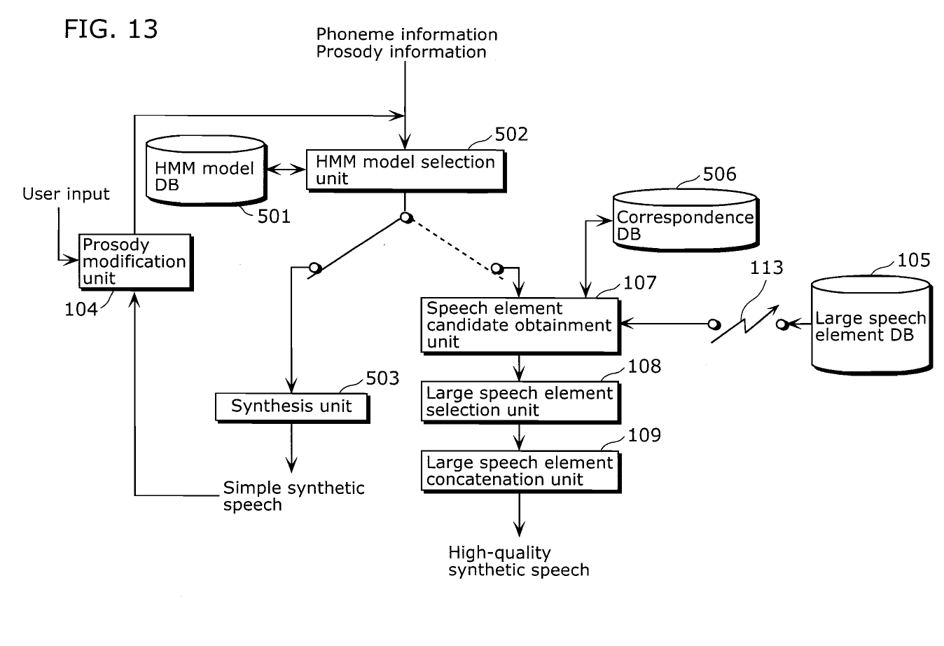

FIG. 13 is a block diagram showing a structure of the multiple quality speech synthesizer in the second embodiment of the present invention. In FIG. 13, structural components which are the same as those in FIG. 2 have been given the same reference numerals and their explanation has not been repeated here.

The multiple quality speech synthesizer is an apparatus that synthesizes speech in multiple qualities, and includes an HMM model DB 501, an HMM model selection unit 502, a synthesis unit 503, the prosody modification unit 104, the large speech element DB 105, a correspondence DB 506, the speech element candidate obtainment unit 107, the large speech element selection unit 108, and the large speech element concatenation unit 109.

The HMM model DB 501 is a database holding HMM models learned on the basis of speech data.

The HMM model selection unit 502 is a processing unit that receives at least an input of phoneme information and prosody information, and selects optimum HMM models from the HMM model DB 501.

The synthesis unit 503 is a processing unit that generates synthetic speech using the HMM models selected by the HMM model selection unit 502.

The correspondence DB 506 is a database that associates the HMM models held in the HMM model DB 501 with speech elements held in the large speech element DB 105.

This embodiment can be implemented as a multiple quality speech synthesis system such as the one shown in FIG. 4, as in the first embodiment. The terminal 111 includes the HMM model DB 501, the HMM model selection unit 502, the synthesis unit 503, the prosody modification unit 104, the correspondence DB 506, the speech element candidate obtainment unit 107, the large speech element selection unit 108, and the large speech element concatenation unit 109, and the server 112 includes the large speech element DB 105.

According to this structure of the multiple quality speech synthesis system, a storage capacity required of the terminal 111 can be reduced (about several MB) because an HMM model file is model-based. Moreover, the large speech element DB 105 (several hundred MB to several GB) can be held in the server 112 in a centralized manner.

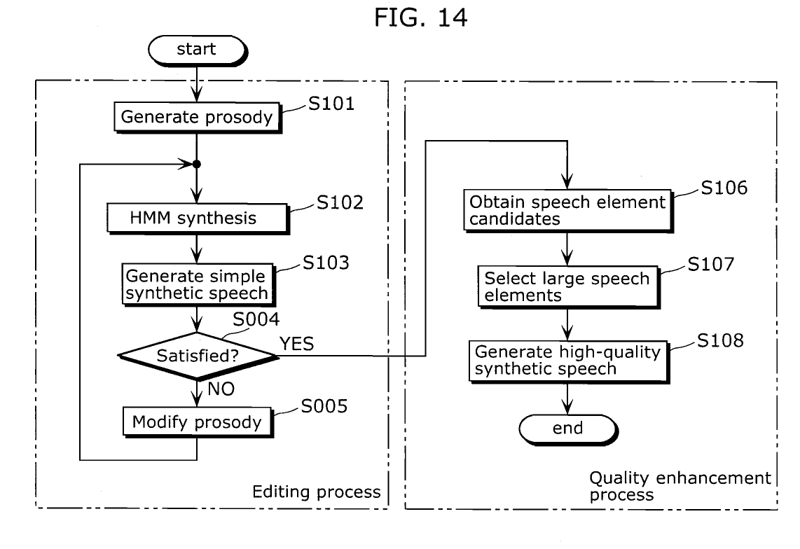

A flow of processing by the multiple quality speech synthesizer in the second embodiment of the present invention is described below, with reference to a flowchart shown in FIG. 14. An operation of the multiple quality speech synthesizer in this embodiment can be divided into a process of editing synthetic speech and a process of enhancing the edited synthetic speech in quality, as with the operation of the multiple quality speech synthesizer in the first embodiment. The synthetic speech editing process and the quality enhancement process are separately described below in sequence.

<Editing Process>

The synthetic speech editing process is described first. As preprocessing, text information inputted by the user is analyzed and prosody information is generated on the basis of a phoneme series and an accent mark (Step S101). A method of generating the prosody information is not specifically limited. For instance, the prosody information may be generated with reference to a template, or estimated using quantification theory type I. Alternatively, the prosody information may be directly inputted from outside.

The HMM model selection unit 502 performs HMM speech synthesis on the basis of the phoneme information and the prosody information obtained in Step S101 (Step S102). In detail, the HMM model selection unit 502 selects optimum HMM models from the HMM model DB 501 according to the inputted phoneme information and prosody information, and generates synthetic parameters from the selected HMM models. Details of this have already been described above, and so its explanation has not been repeated here.

The synthesis unit 503 synthesizes a speech waveform on the basis of the synthetic parameters generated by the HMM model selection unit 502 (Step S103). A method of synthesizing the speech waveform is not specifically limited.

The synthesis unit 503 presents synthetic speech generated in Step S103 to the user by outputting the synthetic speech (Step S004).

The prosody modification unit 104 receives an input of whether or not the user is satisfied with the synthetic speech. When the user is satisfied with the synthetic speech (Step S004: YES), the editing process is completed and the process from Step S106 onward is executed.

When the user is not satisfied with the synthetic speech (Step S004: NO), the prosody modification unit 104 receives an input of information for modifying the prosody information from the user, and modifies the prosody information as the target (Step S005). For example, “modification of prosody information” includes a change in accent position, a change in fundamental frequency, a change in duration, and the like. In this way, the user can modify an unsatisfactory part of the prosody of the synthetic speech. After the modification ends, the operation returns to Step S102. By repeating the process from Steps S102 to S005, synthetic speech of prosody desired by the user can be generated. Through the above steps, the user can generate speech content according to HMM synthesis.

<Quality Enhancement Process>

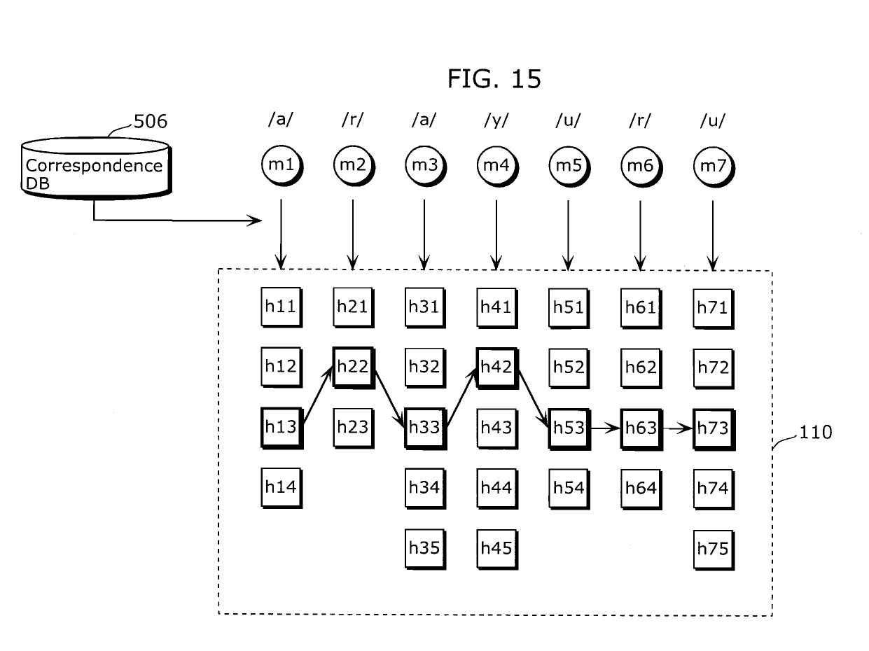

A flow of the quality enhancement process is described next. FIG. 15 shows an operation example of the quality enhancement process.

The speech element candidate obtainment unit 107 obtains speech element candidates from the large speech element DB 105, on the basis of the HMM model series (M=m₁, m₂, . . . , mₙ) last determined in the editing process (Step S106). In detail, the speech element candidate obtainment unit 107 obtains, from the large speech element DB 105, large speech element candidates relating to the HMM models in the HMM model DB 501 which are selected in Step S102, by referencing the correspondence DB 506 which holds the information showing the correspondences between the HMM models held in the HMM model DB 501 and the speech elements held in the large speech element DB 105.

In the example of FIG. 15, the speech element candidate obtainment unit 107 selects, from the large speech element DB 105, large speech elements (h₁₁, h₁₂, h₁₃, h₁₄) corresponding to an HMM model (m₁) which is selected for synthesis of a phoneme “/a/”, with reference to the correspondence DB 506. In the same manner, the speech element candidate obtainment unit 107 can obtain large speech element candidates for HMM models m₂, . . . mₙ from the large speech element DB 105, with reference to the correspondence DB 506. A method of generating the correspondence DB 506 will be described later.

The large speech element selection unit 108 selects a speech element series optimum for the prosody information edited by the user, from the large speech element candidates obtained in Step S106 (Step S107). A method of the selection may be the same as the first embodiment, and so its explanation has not been repeated here. In the example of FIG. 15, a large speech element series H=h₁₃, h₂₂, h₃₃, h₄₂, h₅₃, h₆₃, h₇₃ is obtained.

The large speech element concatenation unit 109 concatenates the speech element series (H=h₁₃, h₂₂, h₃₃, h₄₂, h₅₃, h₆₃, h₇₃) which is held in the large speech element DB 105 and selected in Step S107, to generate synthetic speech (Step S108). A method of the concatenation may be the same as the first embodiment, and so its explanation has not been repeated here.

As a result of the above process, high-quality synthetic speech that is similar in prosody and voice quality to the simple synthetic speech edited in the editing process and uses large speech elements stored in the large speech element DB 105 can be generated.

<Correspondence DB Generation Method>

The correspondence DB 506 is described in detail below.

When generating the correspondence DB 506, an HMM model learning cycle is utilized to associate the HMM models held in the HMM model DB 501 with the speech elements held in the large speech element DB 105.

A method of learning an HMM model held in the HMM model DB 501 is described first. In HMM speech synthesis, a model called “context-dependent model”, which is composed of a combination of contexts such as a preceding phoneme, a current phoneme, and a succeeding phoneme, is used as an HMM model. However, because the number of types of phonemes alone amounts to several tens, a total number of context-dependent models formulated by combination will end up being enormous. This causes a problem of a reduced amount of learning data per context-dependent model. Therefore, context clustering is typically performed. Since context clustering is a known technique, its detailed explanation has been omitted here.

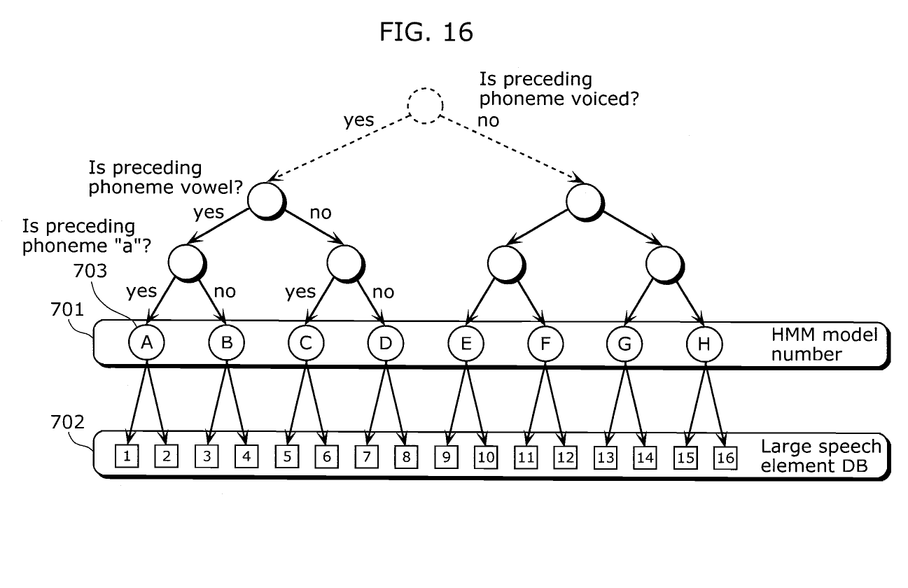

In this embodiment, HMM models are learned using the large speech element DB 105. An example result of performing context clustering on the speech element group held in the large speech element DB 105 upon this learning is shown in FIG. 16. Each speech element of a speech element group 702 in the large speech element DB 105 is shown by a rectangle, with a number denoting an identifier of the speech element. In context clustering, speech samples are classified by context (for example, whether or not a preceding phoneme is voiced). When doing so, speech elements are clustered in stages as indicated by a decision tree shown in FIG. 16.

Here, speech elements having a same context are classified into a leaf node 703 in the decision tree. In the example of FIG. 16, each speech element (speech elements of the speech element numbers “1” and “2”) whose preceding phoneme is a voiced sound, whose preceding phoneme is a vowel, and whose preceding phoneme is “/a/” is classified into the leaf node 703. HMM model learning is conducted for this leaf node 703 using the speech elements of the speech element numbers “1” and “2” as learning data, as a result of which an HMM model of a model number “A” is generated.

Which is to say, in FIG. 16, the HMM model of the model number “A” is learned from the speech elements of the speech element numbers “1” and “2” in the large speech element DB 105. Note that FIG. 16 is a schematic diagram and in actuality each HMM model is learned from many more speech elements.

On the basis of this relation, information showing the correspondence between the HMM model of the model number “A” and the speech elements (speech elements of the speech element numbers “1” and “2”) used for learning the HMM model is held in the correspondence DB 506.

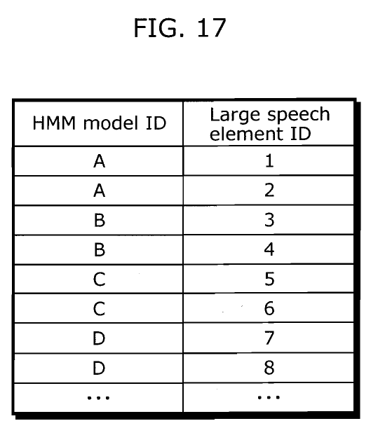

As one example, the correspondence DB 506 such as the one shown in FIG. 17 can be generated by utilizing the above correspondences. In the example of FIG. 17, the HMM model of the model number “A” is associated with the speech elements of the speech element numbers “1” and “2” in the large speech element DB 105. An HMM model of a model number “B” is associated with the speech elements of the speech element numbers “3” and “4” in the large speech element DB 105. In this way, the correspondences between the model numbers of the HMM models of all leaf nodes and the large speech element numbers in the large speech element DB 105 can be held as a table. By holding such a table of correspondences, it is possible to reference the relations between the HMM models and the large speech elements at high speed.

According to the above structure of the correspondence DB 506, each HMM model used for editing and generating synthetic speech in the editing process is associated with speech elements in the large speech element DB 105 which are used for learning the HMM model. This being so, speech element candidates selected from the large speech element DB 105 by the speech element candidate obtainment unit 107 are actual waveforms of learning samples for an HMM model selected from the HMM model DB 501 by the HMM model selection unit 502. Moreover, the speech element candidates and the HMM model are similar in prosody information and voice quality information. The HMM model is generated by statistical processing. Accordingly, corruption occurs when reproducing the HMM model, as compared with the speech elements used for learning the HMM model. That is, an original fine structure of a waveform has been lost due to statistical processing such as averaging of learning samples. However, the speech elements in the large speech element DB 105 are not statistically processed and therefore maintain their original fine structures. Therefore, in terms of sound quality, high-quality synthetic speech can be obtained as compared with synthetic speech which is outputted by the synthetic unit 503 using the HMM model.

In other words, the effect of generating high-quality synthetic speech can be attained by ensuring the similarity in prosody and voice quality according to the relation between the statistical model and its learning data, and also by retaining the speech elements that are not statistically processed and therefore represent fine structures of voice.

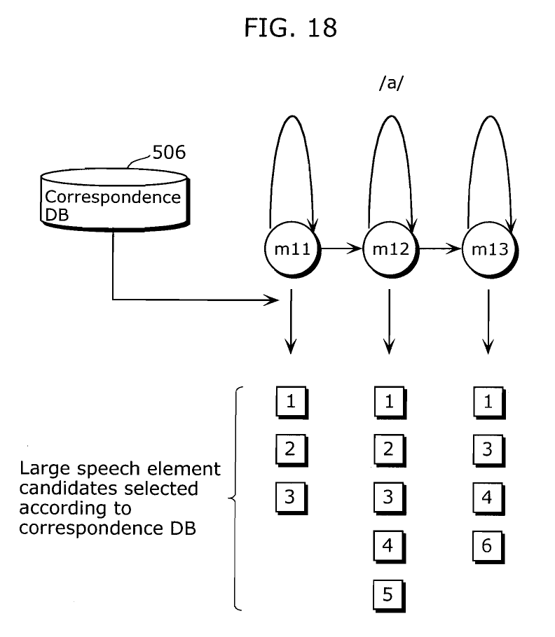

Though the above description assumes that an HMM model is learned in units of phonemes, the unit of learning is not limited to a phoneme. For instance, a plurality of states in an HMM model may be held for one phoneme so that statistics is learned individually for each state, as shown in FIG. 18. FIG. 18 shows an example where an HMM model is formulated in three states for the phoneme “/a/”. In this case, the correspondence DB 506 stores information showing the correspondences between states in HMM models and speech elements stored in the large speech element DB 105.

In the example of FIG. 18, a first state “m11” can be expanded to speech elements (speech element numbers “1”, “2”, and “3”) in the large speech element DB 105 which are used for learning, according to the correspondence DB 506. Moreover, a second state “m12” can be expanded to speech elements (speech element numbers “1”, “2”, “3”, “4”, and “5”) in the large speech element DB 105, according to the correspondence DB 506. Likewise, a last state “m13” can be expanded to speech elements (speech element numbers “1”, “3”, “4”, and “6”) in the large speech element DB 105, according to the correspondence DB 506.

This being the case, the speech element candidate obtainment unit 107 can select speech element candidates by any of the following three criteria.

(1) A set union of large speech elements corresponding to the individual states of the HMM is determined as speech element candidates. In the example of FIG. 18, the large speech elements of the speech element numbers {1, 2, 3, 4, 5, 6} are selected as candidates.

(2) A set intersection of large speech elements corresponding to the individual states of the HMM are determined as speech element candidates. In the example of FIG. 18, the large speech elements of the speech element numbers {1, 3} are selected as candidates.

(3) Speech elements belonging the number of sets equal to or more than a predetermined threshold, among the sets of large speech elements corresponding to the individual states of the HMM, are determined as speech element candidates. Suppose the predetermined threshold is “2”. In the example of FIG. 18, the large speech elements of the speech element numbers {1, 2, 3, 4} are selected as candidates.

Note that these criteria may be used in combination. For instance, when the number of speech element candidates selected by the speech element candidate obtainment unit 107 is below a predetermined number, more speech element candidates may be selected by a different criterion.

According to the above structure, the terminal 111 includes the HMM model DB 501, the HMM model selection unit 502, the synthesis unit 503, the prosody modification unit 104, the correspondence DB 506, the speech element candidate obtainment unit 107, the large speech element selection unit 108, and the large speech element concatenation unit 109, whereas the server 112 includes the large speech element DB 105. Hence the terminal 111 is not required to have a large storage capacity. In addition, since the large speech element DB 105 can be held in the server 112 in a centralized manner, it is sufficient to hold only one large speech element DB 105 in the server 112 even in the case where there are two or more terminals 111.

For the editing process, synthetic speech can be generated using HMM speech synthesis by the terminal 111 alone. In addition, the prosody modification unit 104 allows the user to perform synthetic speech editing. Here, HMM speech synthesis makes it possible to generate synthetic speech at extremely high speed, when compared with the case where the large speech element DB 105 is searched for speech synthesis. Accordingly, the cost of computation in synthetic speech editing can be reduced, and synthetic speech can be edited with high responsiveness even when editing is performed a plurality of times.

Furthermore, after the editing process is completed, the quality enhancement process can be performed using the large speech element DB 105 held in the server 112. Here, the correspondence DB 506 shows the correspondences between model numbers of HMM models already determined in the editing process and speech element numbers of speech element candidates in the large speech element DB 105. Accordingly, the selection of speech elements by the large speech element selection unit 108 can be performed just by searching a limited search space. This contributes to a significant reduction in computation amount, when compared with the case of re-selecting speech elements once again.

Moreover, the communication between the terminal 111 and the server 112 needs to be performed only once, namely, at the time of the quality enhancement process. Hence a time loss associated with communication can be reduced. In other words, by separating the speech content editing process and the quality enhancement process, it is possible to improve responsiveness for the speech content editing process.

Furthermore, while speech waveforms themselves, though small in number, need to be held in the terminal in the first embodiment, the terminal in this embodiment only needs to hold a file of HMM models. This further reduces the storage capacity required of the terminal.

In this embodiment too, the structural components may be divided between the terminal and the server as shown in the variations 1 to 4 in the first embodiment. In such a case, the small speech element DB 101, the small speech element selection unit 102, the small speech element concatenation unit 103, and the correspondence DB 106 respectively correspond to the HMM model DB 501, the HMM model selection unit 502, the synthesis unit 503, and the correspondence DB 506.

### Third Embodiment

When the generation of synthetic speech is regarded as the generation (editing) of speech content as described above, there is a case where the generated speech content is provided to a third party. This corresponds to a situation where a content generator and a content user are different. One example of providing speech content to a third party is given below. In the case of generating speech content using a mobile phone or the like, there is a speech content distribution pattern in which a generator of the speech content transmits the generated speech content via a network or the like and a receiver receives the speech content. In detail, in the case of transmission/reception of a voice message using electronic mail and the like, a service for transmitting the speech content generated by the generator to the other party in communication may be used.

In such a case, importance lies in which information is to be communicated. When the transmitter and the receiver share the same small speech element DB 101 or the same HMM model DB 501, the information necessary for distribution can be reduced.

In addition, there may be a usage pattern that, for example, the generator performs the editing process of the speech content and the receiver pre-listens the received speech content and, when he/she likes the speech content, performs the quality enhancement process.

A third embodiment of the present invention relates to a method of communicating generated speech content and a method of a quality enhancement process.

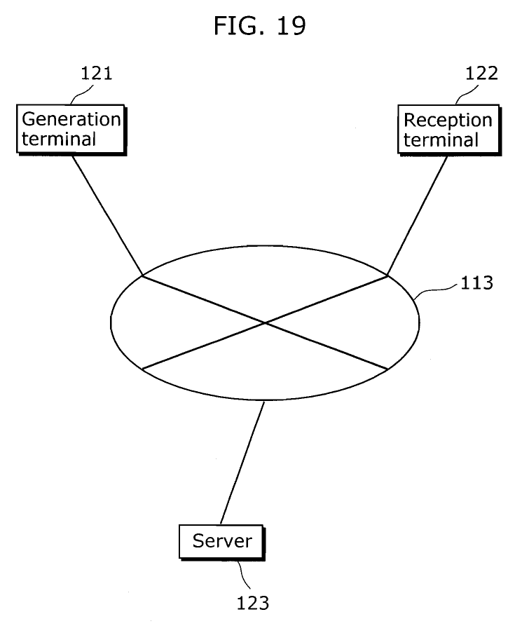

FIG. 19 is a block diagram showing a structure of a multiple quality speech synthesis system in the third embodiment of the present invention. This embodiment differs from the first and second embodiments in that the editing process is performed by the speech content generator and the quality enhancement process is performed by the speech content receiver, and a communication means is provided between a terminal used by the generator and a terminal used by the receiver.

The multiple quality speech synthesis system includes a generation terminal 121, a reception terminal 122, and a server 123. The generation terminal 121, the reception terminal 122, and the server 123 are connected to each other via the network 113.

The generation terminal 121 is an apparatus that is used by the speech content generator to edit speech content. The reception terminal 122 is an apparatus that receives the speech content generated by the generation terminal 121. The reception terminal 122 is used by the speech content receiver. The server 123 is an apparatus that holds the large speech element DB 105 and performs the quality enhancement process on the speech content.

Functions of the generation terminal 121, the reception terminal 122, and the server 123 are described below, on the basis of the structure of the first embodiment. The generation terminal 121 includes the small speech element DB 101, the small speech element selection unit 102, the small speech element concatenation unit 103, and the prosody modification unit 104. The reception terminal 122 includes the correspondence DB 106, the speech element candidate obtainment unit 107, the large speech element selection unit 108, and the large speech element concatenation unit 109. The server 123 includes the large speech element DB 105.

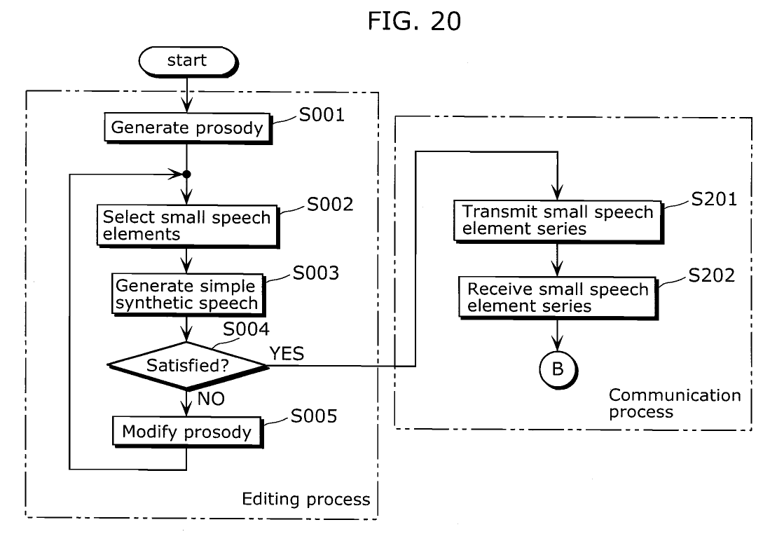

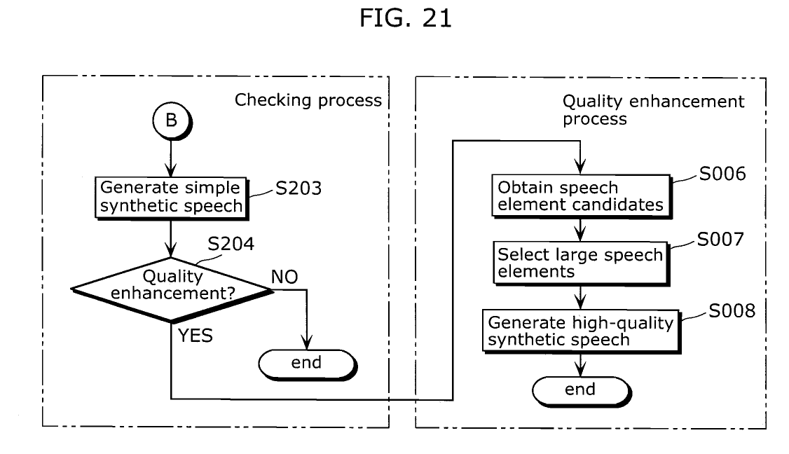

FIGS. 20 and 21 are flowcharts showing a flow of processing by the multiple quality speech synthesis system in the third embodiment.

The processing by the multiple quality speech synthesis system can be divided into four processes that are an editing process, a communication process, a checking process, and a quality enhancement process. Each of these processes is described below.

<Editing Process>

The editing process is executed in the generation terminal 121. The process may be the same as that in the first embodiment. In brief, text information inputted by the user is analyzed and prosody information is generated on the basis of a phoneme series and an accent mark, as preprocessing (Step S001).

The small speech element selection unit 102 selects an optimum speech element series from the small speech element DB 101 according to the prosody information obtained in Step S001, in consideration of distances (target cost (Ct)) from the target prosody and concatenability (concatenation cost (Cc)) of speech elements (Step S002). In detail, the small speech element selection unit 102 searches for a speech element series for which the cost shown by the above Expression (1) is minimum, by the Viterbi algorithm.

The small speech element concatenation unit 103 synthesizes a speech waveform using the speech element series selected by the small speech element selection unit 102, and presents synthetic speech to the user by outputting the synthetic speech (Step S003).

The prosody modification unit 104 receives an input of whether or not the user is satisfied with the synthetic speech. When the user is satisfied with the synthetic speech (Step S004: YES), the editing process is completed and the process from Step S201 onward is executed.

When the user is not satisfied with the synthetic speech (Step S004: NO), the prosody modification unit 104 receives an input of information for modifying the prosody information from the user, and modifies the prosody information as the target (Step S005). After the modification ends, the operation returns to Step S002. By repeating the process from Steps S002 to S005, synthetic speech of prosody desired by the user can be generated.

<Communication Process>

The communication process is described next.

The generation terminal 121 transmits the small speech element series and the prosody information determined as a result of the editing process performed in the generation terminal 121, to the reception terminal 122 via the network such as the Internet (Step S201). A method of the communication is not specifically limited.

The reception terminal 122 receives the prosody information and the small speech element series transmitted in Step S201 (Step S202).

As a result of this communication process, the reception terminal 122 can obtain minimum information for reconstructing the speech content generated in the generation terminal 121.

<Checking Process>

The checking process is described next.

The reception terminal 122 obtains speech elements of the small speech element series received in Step S202, from the small speech element DB 101. The reception terminal 122 then generates synthetic speech in accordance with the prosody information received from the small speech element concatenation unit 103 (Step S203). The process of generating the synthetic speech is the same as in Step S003.

The receiver checks the simple synthetic speech generated in Step S203, and the reception terminal 122 receives a result of judgment by the receiver (Step S204). When the receiver judges that the simple synthetic speech is sufficient (Step S204: NO), the reception terminal 122 adopts the simple synthetic speech as speech content. When the receiver requests quality enhancement (Step S204: YES), on the other hand, the quality enhancement process from Step S006 onward is carried out.

<Quality Enhancement Process>

The quality enhancement process is described next.

The speech element candidate obtainment unit 107 in the reception terminal 122 transmits the small speech element series to the server 123, and the server 123 obtains speech element candidates from the large speech element DB 105 with reference to the correspondence DB 106 in the reception terminal 122 (Step S006).

The large speech element selection unit 108 selects a large speech element series that satisfies the above Expression (1), using the prosody information and the speech element candidates obtained in Step S006 (Step S007).

The large speech element concatenation unit 109 concatenates the large speech element series selected in Step S007 to generate high-quality synthetic speech (Step S008).

According to the above structure, when transmitting the speech content generated in the generation terminal 121 to the reception terminal 122, only the prosody information and the small speech element series need to be transmitted. Therefore, the amount of communication between the generation terminal 121 and the reception terminal 122 can be reduced when compared with the case of transmitting the synthetic speech itself.

Moreover, the generation terminal 121 can edit the synthetic speech using only the small speech element series. Since the generation terminal 121 is not required to generate high-quality synthetic speech through the server 123, the speech content generation can be simplified.

In addition, in the reception terminal 122, the synthetic speech is generated on the basis of the prosody information and the small speech element series, and the generated synthetic speech is checked by pre-listening before the quality enhancement process. Thus, the speech content can be pre-listened without accessing the server 123. Only when the receiver wants to enhance the pre-listened speech content in quality, the quality enhancement is performed by accessing the server 123. In this way, the receiver is allowed to freely select simple speech content or high-quality speech content.

Furthermore, in the speech element selection process with the large speech element DB 105, the use of the correspondence DB 106 makes it possible to select only the speech elements corresponding to the small speech element series as the candidates. This has the effect of reducing the amount of communication between the reception terminal 122 and the server 123 and enabling the quality enhancement process to be performed efficiently.

The above describes the case where the reception terminal 122 includes the correspondence DB 106, the speech element candidate obtainment unit 107, the large speech element selection unit 108, and the large speech element concatenation unit 109 while the server 123 includes the large speech element DB 105. As an alternative, the server 123 may include the large speech element DB 105, the speech element candidate obtainment unit 107, the large speech element selection unit 108, and the large speech element concatenation unit 109.

In this case, the effect of reducing the amount of processing in the reception terminal and the effect of reducing the communication between the reception terminal and the server can be attained.

The above description is based on the structure of the first embodiment, but the functions of the generation terminal 121, the reception terminal 122, and the server 123 may instead be realized with the structure of the second embodiment. In such a case, the generation terminal 121 includes the HMM model DB 501, the HMM model selection unit 502, the synthesis unit 503, and the prosody modification unit 104, the reception terminal 122 includes the correspondence DB 506, the speech element candidate obtainment unit 107, the large speech element selection unit 108, and the large speech element concatenation unit 109, and the server 123 includes the large speech element DB 105, as one example.

### INDUSTRIAL APPLICABILITY

The present invention can be applied to a speech synthesizer, and in particular to a speech synthesizer and the like for generating speech content used in a mobile phone and the like.

1. A speech synthesis system that generates synthetic speech which conforms to phonetic symbols and prosody information, said speech synthesis system comprising a generation terminal, a server, and a reception terminal that are connected to each other via a computer network,
said generation terminal including:
a small database holding pieces of synthetic speech generation data used for generating synthetic speech; and
a synthetic speech generation data selection unit configured to select, from said small database, pieces of synthetic speech generation data from which synthetic speech that best conforms to the phonetic symbols and the prosody information is to be generated,
said server including
a large database holding speech elements which are greater in number than the pieces of synthetic speech generation data held in said small database and from which synthetic speech that can represent more detailed prosody information than the pieces of synthetic speech generation data held in said small database is to be generated, and
said reception terminal including:
a conforming speech element selection unit configured to select, from said large database, speech elements which correspond to the pieces of synthetic speech generation data selected by said synthetic speech generation data selection unit and from which synthetic speech that best conforms to the phonetic symbols and the prosody information is to be generated; and
a speech element concatenation unit configured to generate synthetic speech by concatenating the speech elements selected by said conforming speech element selection unit.

2. A generation terminal that generates simple synthetic speech which conforms to phonetic symbols and prosody information, said generation terminal comprising:
a small database holding speech elements used for generating synthetic speech;
a synthetic speech generation data selection unit configured to select, from said small database, pieces of synthetic speech generation data from which synthetic speech that conforms to the phonetic symbols and the prosody information is to be generated; and
a transmission unit configured to transmit the pieces of synthetic speech generation data,
wherein said transmission unit is configured to transmit, to a server that includes a large database holding speech elements which are greater in number than the speech elements held in said small database, the pieces of synthetic speech generation data to be associated with speech elements in the large database.

3. The generation terminal according to claim 2, further comprising:
a small speech element concatenation unit configured to generate simple synthetic speech by concatenating speech elements selected by said synthetic speech generation data selection unit; and
a prosody information modification unit configured to receive information for modifying prosody information of the simple synthetic speech and modify the prosody information according to the received information,
wherein said synthetic speech generation data selection unit is configured to, when the prosody information of the simple synthetic speech is modified, re-select, from said small database, pieces of synthetic speech generation data from which synthetic speech that conforms to the phonetic symbols and the modified prosody information is to be generated, and output the re-selected pieces of synthetic speech generation data to said small speech element concatenation unit, and
said transmission unit is configured to transmit the pieces of synthetic speech data determined as a result of the modification and the re-selection.

4. A server that generates synthetic speech which conforms to phonetic symbols and prosody information, said server comprising:
a reception unit configured to receive pieces of synthetic speech generation data generated by a generation terminal;
a large database holding speech elements which are greater in number than pieces of synthetic speech generation data held in a small database; and
a correspondence database holding correspondence information that shows a relation between each piece of synthetic speech generation data held in the small database and one or more speech elements corresponding to the piece of synthetic speech generation data.

5. A speech synthesizer that generates synthetic speech which conforms to phonetic symbols and prosody information, said speech synthesizer comprising:
a small database holding pieces of synthetic speech generation data used for generating synthetic speech;
a large database holding speech elements which are greater in number than the pieces of synthetic speech generation data held in said small database;
a synthetic speech generation data selection unit configured to select, from said small database, pieces of synthetic speech generation data from which synthetic speech that conforms to the phonetic symbols and the prosody information is to be generated;
a conforming speech element selection unit configured to select, from said large database, speech elements which correspond to the pieces of synthetic speech generation data selected by said synthetic speech generation data selection unit; and
a speech element concatenation unit configured to generate synthetic speech by concatenating the speech elements selected by said conforming speech element selection unit.

6. The speech synthesizer according to claim 5, further comprising:
a small speech element concatenation unit configured to generate simple synthetic speech by concatenating speech elements selected by said synthetic speech generation data selection unit; and
a prosody information modification unit configured to receive information for modifying prosody information of the simple synthetic speech and modify the prosody information according to the received information,
wherein said synthetic speech generation data selection unit is configured to, when the prosody information of the simple synthetic speech is modified, re-select, from said small database, pieces of synthetic speech generation data from which synthetic speech that conforms to the phonetic symbols and the modified prosody information is to be generated, and output the re-selected pieces of synthetic speech generation data to said small speech element concatenation unit, and
said conforming speech element selection unit is configured to receive the pieces of synthetic speech generation data determined as a result of the modification and the re-selection, and select, from said large database, speech elements which correspond to the received pieces of synthetic speech generation data.

7. The speech synthesizer according to claim 5, further comprising
a correspondence database holding correspondence information that shows a relation between each piece of synthetic speech generation data held in said small database and one or more speech elements corresponding to the piece of synthetic speech generation data,
wherein said conforming speech element selection unit includes:
a speech element obtainment unit configured to specify, using the correspondence information held in said correspondence database, speech elements that correspond to the pieces of synthetic speech generation data selected by said synthetic speech generation data selection unit, and obtain the specified speech elements from said large database as candidates; and
a speech element selection unit configured to select, from the speech elements obtained by said speech element obtainment unit as the candidates, speech elements from which synthetic speech that best conforms to the phonetic symbols and the prosody information is to be generated,
wherein said speech element concatenation unit is configured to generate the synthetic speech by concatenating the speech elements selected by said speech element selection unit.

8. The speech synthesizer according to claim 5,
wherein said large database is provided in a server that is connected to said speech synthesizer via a computer network, and
said conforming speech element selection unit is configured to select the speech elements from said large database provided in the server.

9. The speech synthesizer according to claim 5,
wherein said small database holds speech elements each of which is representative of a different one of clusters generated by clustering the speech elements held in said large database.

10. The speech synthesizer according to claim 9,
wherein said small database holds speech elements each of which is representative of a different one of clusters generated by clustering the speech elements held in said large database in accordance with at least one of a fundamental frequency, a duration, power information, a formant parameter, and a cepstrum coefficient of each of the speech elements.

11. The speech synthesizer according to claim 5,
wherein said small database holds hidden Markov models, and
said large database holds speech elements that are learning samples used when generating the hidden Markov models held in said small database.

12. A speech synthesis method for generating synthetic speech which conforms to phonetic symbols and prosody information, said speech synthesis method comprising:
selecting, from a small database holding pieces of synthetic speech generation data used for generating synthetic speech, pieces of synthetic speech generation data from which synthetic speech that best conforms to the phonetic symbols and the prosody information is to be generated;
selecting, from a large database holding speech elements which are greater in number than the pieces of synthetic speech generation data held in the small database and from which synthetic speech that can represent more detailed prosody information than the pieces of synthetic speech generation data held in the small database is to be generated, speech elements which correspond to the pieces of synthetic speech generation data selected in said selecting pieces of synthetic speech generation data and from which synthetic speech that best conforms to the phonetic symbols and the prosody information is to be generated; and
generating synthetic speech by concatenating the speech elements selected in said selecting speech elements.

13. A program for generating synthetic speech which conforms to phonetic symbols and prosody information, said program causing a computer to execute:
selecting, from a small database holding pieces of synthetic speech generation data used for generating synthetic speech, pieces of synthetic speech generation data from which synthetic speech that best conforms to the phonetic symbols and the prosody information is to be generated;
selecting, from a large database holding speech elements which are greater in number than the pieces of synthetic speech generation data held in the small database and from which synthetic speech that can represent more detailed prosody information than the pieces of synthetic speech generation data held in the small database is to be generated, speech elements which correspond to the pieces of synthetic speech generation data selected in said selecting pieces of synthetic speech generation data and from which synthetic speech that best conforms to the phonetic symbols and the prosody information is to be generated; and
generating synthetic speech by concatenating the speech elements selected in said selecting speech elements.
